(19) United States
(12) Patent Application Publication
(10) Pub. No.: US 2025/0060570 A1
(43) Pub. Date: Feb. 20, 2025

(54) PROJECTION OPTICAL SYSTEM AND PROJECTION TYPE DISPLAY DEVICE

(71) Applicant: FUJIFILM Corporation, Tokyo (JP)

(72) Inventor: Masanao KAWANA, Saitama-shi (JP)

(73) Assignee: FUJIFILM Corporation, Tokyo (JP)

(21) Appl. No.: 18/806,631

(22) Filed: Aug. 15, 2024

(30) Foreign Application Priority Data
Aug. 17, 2023 (JP) 2023-132916

(51) Int. Cl. G02B 15/14; G02B 5/04; G02B 13/02

(52) U.S. Cl. CPC G02B 15/1421; G02B 5/04; G02B 13/02

(57) ABSTRACT

The projection optical system projects an image on a reduction side to a magnification side, does not include a reflecting surface having a power, and consists of, in order from the magnification side to the reduction side along an optical path, a first optical system and a second optical system. An intermediate image is formed between the first optical system and the second optical system, and the first optical system includes an optical path deflection surface which deflects an optical path. Assuming that a radius of a maximum effective image circle on the reduction side is Imax, a distance on an optical axis from a lens surface closest to the magnification side in the first optical system to the optical path deflection surface is Ddef, 0.2<Imax/Ddef<0.7 is satisfied.

### CROSS-REFERENCE TO RELATED APPLICATIONS

This application claims priority from Japanese Patent Application No. 2023-132916, filed on Aug. 17, 2023, the entire disclosure of which is incorporated herein by reference.

### BACKGROUND

### Technical Field

The technique of the present disclosure relates to a projection optical system and a projection type display device.

### Related Art

An optical system described in JP2014-029392A below is known as an optical system applicable to a projection type display device.

### SUMMARY

There is a demand for a projection optical system which is configured to have a small size and has favorable optical performance. The demand levels are increasing year by year.

The present disclosure has been made in view of the above-mentioned circumstances, and provides a projection optical system which is configured to have a small size and has favorable optical performance, and a projection type display device comprising the projection optical system.

According to a first aspect of the present disclosure, there is provided a projection optical system that projects an image on a reduction side to a magnification side, in which the projection optical system does not include a reflecting surface having a power, the projection optical system consists of, in order from the magnification side to the reduction side along an optical path, a first optical system and a second optical system, an intermediate image is formed between the first optical system and the second optical system, and the first optical system includes an optical path deflection surface which deflects an optical path, Conditional Expression (1) is satisfied, which is represented by

$$0.2 < Imax / Ddef < 0.7 . \qquad ( 1 )$$

In the present disclosure, the symbols of Conditional Expressions are defined as follows. It is assumed that a radius of a maximum effective image circle on the reduction side is Imax. It is assumed that a distance on an optical axis from a lens surface closest to the magnification side in the first optical system to the optical path deflection surface is Ddef. It is assumed that Ddef is a value at a wide-angle end in a case where the projection optical system is a variable magnification optical system.

According to a second aspect of the present disclosure, in the projection optical system of the first aspect, the first optical system consists of, in order from the magnification side to the reduction side along the optical path, a front group that has a negative power, an optical path deflection member that includes the optical path deflection surface, and a rear group that has a positive power.

According to a third aspect of the present disclosure, in the projection optical system of the second aspect, the front group includes one or more positive lenses.

According to a fourth aspect of the present disclosure, in the projection optical system of the second aspect, an outermost periphery of an optical effective surface closest to the magnification side in the first optical system is positioned closer to the reduction side in an optical axis direction than an intersection between the optical effective surface and the optical axis.

According to a fifth aspect of the present disclosure, in the projection optical system of the third aspect, assuming that an average value of Abbe numbers of all negative lenses included in the front group based on a d line is vnave, and an average value of Abbe numbers of all positive lenses included in the front group based on the d line is vpave, Conditional Expression (2) is satisfied, which is represented by

$$10 < ν nave - ν pave < 40. \qquad ( 2 )$$

According to a sixth aspect of the present disclosure, in the projection optical system of the third aspect, assuming that an average value of refractive indexes of all negative lenses included in the front group at a d line is Nnave, and an average value of refractive indexes of all positive lenses included in the front group at the d line is Npave, Conditional Expression (3) is satisfied, which is represented by

$$0.15 < Npave - Nnave < 0.45 . \qquad ( 3 )$$

According to a seventh aspect of the present disclosure, in the projection optical system of the second aspect, at least a part of the rear group moves during focusing.

According to an eighth aspect of the present disclosure, in the projection optical system of the first aspect, the second optical system includes two or more movable groups that move along the optical axis during magnification change.

According to a ninth aspect of the present disclosure, in the projection optical system of the eighth aspect, a movable group closest to the magnification side among the movable groups of the second optical system has a positive power.

According to a tenth aspect of the present disclosure, in the projection optical system of the second aspect, assuming that an air conversion distance on the optical axis from a surface closest to the reduction side in the front group to a surface closest to the magnification side in the rear group is Dfr, and Dfr is a value at the wide-angle end in a case where the projection optical system is a variable magnification optical system, Conditional Expression (4) is satisfied, which is represented by

$$0.5 < Imax / Dfr < 0.9 . \qquad ( 4 )$$

According to an eleventh aspect of the present disclosure, in the projection optical system of the second aspect, the optical path deflection surface is a surface of a prism.

According to a twelfth aspect of the present disclosure, in the projection optical system of the eleventh aspect, assuming that a thickness of the prism along the optical axis is Dpr, and a refractive index of the prism at the d line is Npr, Conditional Expression (5) is satisfied, which is represented by

$$0.9 < Imax / ( Dpr / Npr ) < 1.3 . \qquad ( 5 )$$

According to a thirteenth aspect of the present disclosure, in the projection optical system of the first aspect, assuming that a maximum effective radius of the lens surface closest to the magnification side in the first optical system is ERf, and a maximum value of maximum effective radii of all lens surfaces of the projection optical system is ERmax, Conditional Expression (6) is satisfied, which is represented by

$$0 < ERf / ERmax < 0.7 . \qquad ( 6 )$$

According to a fourteenth aspect of the present disclosure, in the projection optical system of the first aspect, assuming that a maximum value of a height of an on-axis marginal ray from the optical axis on all lens surfaces of the first optical system is AH1, and a maximum value of a height of the on-axis marginal ray from the optical axis on all lens surfaces of the second optical system is AH2, Conditional Expression (7) is satisfied, which is represented by

$$0 < AH 1 / AH 2 < 0.7 . \qquad ( 7 )$$

According to a fifteenth aspect of the present disclosure, in the projection optical system of the first aspect, the projection optical system includes an aperture stop at a position closer to the reduction side than the intermediate image, a real image of the aperture stop is present inside the first optical system, and assuming that a position of the real image in an optical axis direction is set as a first position, and a position farthest from the first position is set as a second position, among positions where a ray, which is emitted from an optional point in a maximum effective image circle on the reduction side and passes through a center of the aperture stop toward the magnification side, intersects the optical axis at a position closer to the magnification side than the intermediate image, an intersection between the optical path deflection surface and the optical axis is positioned within a range from the first position to the second position in the optical axis direction.

According to a sixteenth aspect of the present disclosure, in the projection optical system of the fifteenth aspect, assuming that a natural number of 1 to 10 is k, a point, of which a height from the optical axis on the maximum effective image circle on the reduction side is a height of k tenths of a radius of the maximum effective image circle, is a point PHk, a position, at which a ray that is emitted from the point PHk and that passes through the center of the aperture stop toward the magnification side intersects the optical axis at the position closer to the magnification side than the intermediate image, is a position Pk, a position, at which an air conversion distance on the optical axis from the first position is longest, among the positions Pk is a third position, an air conversion distance from the first position to the third position is DifP, a sign of DifP is positive at a distance on the reduction side and is negative at a distance on the magnification side, in a case where the first position is set as a reference, and DifP is a value at the wide-angle end in a case where the projection optical system is a variable magnification optical system, Conditional Expression (8) is satisfied, which is represented by

$$- 3 < DifP / Imax < - 0.2 . \qquad ( 8 )$$

According to a seventeenth aspect of the present disclosure, in the projection optical system of the sixteenth aspect, the first optical system consists of, in order from the magnification side to the reduction side along the optical path, a front group, an optical path deflection member that includes the optical path deflection surface, and a rear group, and assuming that an air conversion distance on the optical axis from a surface closest to the reduction side in the front group to a surface closest to the magnification side in the rear group is Dfr, and Dfr is a value at the wide-angle end in a case where the projection optical system is a variable magnification optical system, Conditional Expression (9) is satisfied, which is represented by

$$0.4 < \vert DifP / Dfr \vert < 0.7 . \qquad ( 9 )$$

According to an eighteenth aspect of the present disclosure, in the projection optical system of the sixteenth aspect, the optical path deflection surface is a surface of a prism.

According to a nineteenth aspect of the present disclosure, in the projection optical system of the eighteenth aspect, assuming that a thickness of the prism along the optical axis is Dpr, and a refractive index of the prism at the d line is Npr, Conditional Expression (10) is satisfied, which is represented by

$$0.7 < \vert DifP / ( Dpr / Npr ) \vert < 1.8 . \qquad ( 10 )$$

According to a twentieth aspect of the present disclosure, there is provided a projection type display device comprising: the projection optical system according to any one of the first to nineteenth aspects.

In the present specification, it should be noted that the terms “consisting of” and “consists of” mean that the lens may include not only the above-mentioned components but also lenses substantially having no powers (refractive powers), optical elements, which are not lenses, such as a stop, a mask, a filter, a cover glass, a planar mirror, and a prism, and mechanism parts such as a lens flange, a lens barrel, an imaging element, and a camera shaking correction mechanism.

In the present specification, the terms “group that has a positive power” and “group that has a positive power” mean that the group as a whole has a positive power. Similarly, the terms “group that has a negative power” and “group that has a negative power” mean that the group as a whole has a negative power. The terms “front group”, “rear group”, “focusing group”, and “lens group” in the present specification are not limited to a configuration consisting of a plurality of lenses, but may be a configuration consisting of only one lens.

A compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The sign of the power, and the surface shape of the lens including the aspherical surface will be used in terms of the paraxial region unless otherwise specified. Unless otherwise specified, the “distance on the optical axis” used in Conditional Expression is considered as a geometrical distance. The “focal length” used in a conditional expression is a paraxial focal length. The values used in conditional expressions are values in a case where the d line is set as a reference.

The “d line”, “C line”, and “F line” described in the present specification are bright lines, the wavelength of the d line is 587.56 nanometers (nm), the wavelength of the C line is 656.27 nanometers (nm), and the wavelength of the F line is 486.13 nanometers (nm).

According to the present disclosure, it is possible to provide a projection optical system which is configured to have a small size and has favorable optical performance, and a projection type display device comprising the projection optical system.

### BRIEF DESCRIPTION OF THE DRAWINGS

FIG. 1 is a cross-sectional view showing a configuration and luminous flux of a projection optical system according to an embodiment corresponding to a projection optical system of Example 1.

FIG. 2 is a partially enlarged view of the projection optical system of FIG. 1.

FIG. 3 is a cross-sectional view showing a configuration, in which an optical path of the projection optical system of FIG. 1 is expanded, and luminous flux.

FIG. 4 is a diagram for explaining a maximum effective radius.

FIG. 5 is a diagram showing a ray of light which is emitted from a point within a maximum effective image circle on a reduction side and which passes through a center of an aperture stop toward a magnification side in the projection optical system of FIG. 1.

FIG. 6 is an enlarged view of a main portion of FIG. 5.

FIG. 7 is a diagram showing a ray which is emitted from a point PHk on the reduction side to the magnification side and which passes through the center of the aperture stop in the projection optical system of FIG. 1.

FIG. 8 is an enlarged view of a main portion of FIG. 7.

FIG. 9 is a diagram of aberrations in a projection optical system of Example 1.

FIG. 10 is a cross-sectional view showing a configuration and luminous flux of a projection optical system of Example 2.

FIG. 11 is a cross-sectional view showing a configuration, in which an optical path of the projection optical system of FIG. 10 is expanded, and luminous flux.

FIG. 12 is a diagram of aberrations in the projection optical system of Example 2.

FIG. 13 is a cross-sectional view showing a configuration and luminous flux of a projection optical system of Example 3.

FIG. 14 is a cross-sectional view showing a configuration, in which an optical path of the projection optical system of FIG. 13 is expanded, and luminous flux.

FIG. 15 is a diagram of aberrations in the projection optical system of Example 3.

FIG. 16 is a cross-sectional view showing a configuration and luminous flux of a projection optical system of Example 4.

FIG. 17 is a cross-sectional view showing a configuration, in which an optical path of the projection optical system of FIG. 16 is expanded, and luminous flux.

FIG. 18 is a diagram of aberrations in the projection optical system of Example 4.

FIG. 19 is a schematic configuration diagram of a projection type display device according to an embodiment.

FIG. 20 is a schematic configuration diagram of a projection type display device according to another embodiment.

FIG. 21 is a schematic configuration diagram of a projection type display device according to another embodiment.

FIG. 22 is a schematic configuration diagram of a projection type display device according to another embodiment.

### DESCRIPTION OF EMBODIMENTS

Hereinafter, embodiments of the present disclosure will be described with reference to the accompanying drawings.

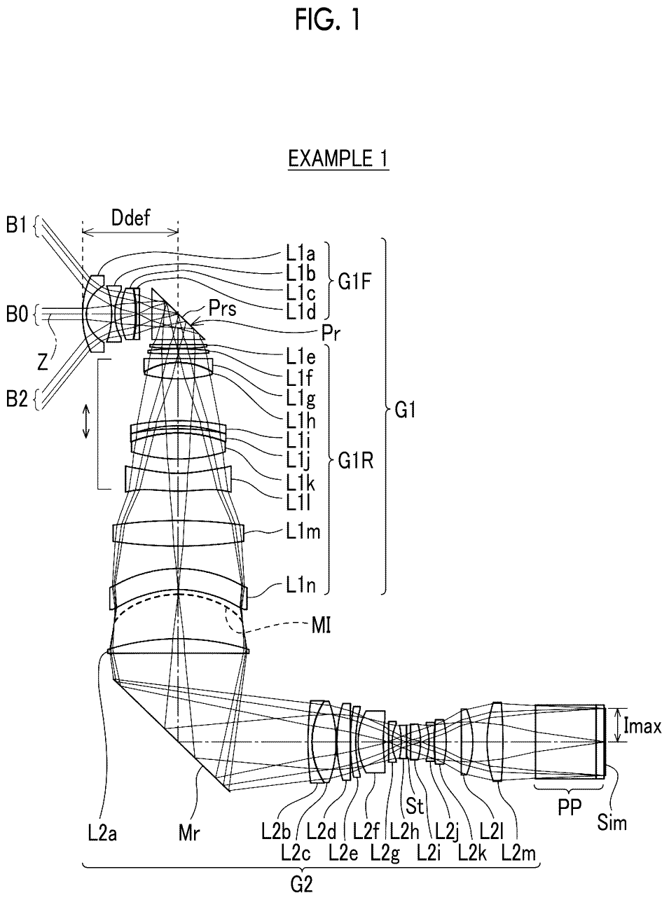

FIG. 1 shows a configuration of a projection optical system and a cross-sectional view of luminous flux according to an embodiment of the present disclosure. FIG. 1 shows, as the luminous flux, on-axis luminous flux B0 and luminous flux B1 and B2 with the maximum angle of view. The example shown in FIG. 1 corresponds to a projection optical system of Example 1 to be described later. In FIG. 1, the upper left side is the magnification side and the lower right side is the reduction side.

FIG. 1 shows an example in which an optical member PP and a display surface Sim of a light valve are disposed on the reduction side of the projection optical system on the assumption that the projection optical system is mounted on the projection type display device. The light valve is a display element which outputs an optical image, and the optical image is displayed as an image on the display surface Sim. As the light valve, for example, a liquid crystal display element or an image display element such as digital micromirror device (DMD: registered trademark) can be used. The optical member PP is a member which is regarded as a filter, a cover glass, a color synthesis prism, or the like. The optical member PP is a member having no power. The material, the length, and the number of components of the optical member PP can be appropriately changed. A configuration in which the optical member PP is omitted is also possible.

The projection optical system is, for example, mounted on a projection type display device and projects an image, which is displayed on the display surface Sim of the display element on the reduction side, onto a projection surface on the magnification side, in an enlarged manner. In the projection type display device, luminous flux provided with image information on the display surface Sim is incident on the projection optical system through the optical member PP, and is projected onto the screen (not shown in the drawing) which is the projection surface through the projection optical system. That is, the display surface Sim and the screen are positioned at optically conjugate positions. The display surface Sim corresponds to the reduction side conjugate plane, and the screen corresponds to the magnification side conjugate plane. It should be noted that, in the present specification, the term “screen” means an object on which a projected image formed by the projection optical system is projected. The screen may be not only a dedicated screen but also a wall surface of a room, a floor surface, a ceiling surface, an outer wall surface of a building, or the like.

In the description of the present specification, the term “magnification side” means the screen side on an optical path, and the term “reduction side” means the display surface Sim side on the optical path. In the present specification, the “magnification side” and the “reduction side” are determined along the optical path. Further, the term “adjacent” in the disposition of the components means that the components are adjacent to each other in the arrangement order on the optical path. In the following description, in order to avoid making the description redundant, the phrase “in order from the magnification side to the reduction side along the optical path” may be described as “in order from the magnification side to the reduction side”.

The projection optical system according to the present disclosure is configured not to include a reflecting surface which has a power. The projection optical system may adopt a configuration in which the center position of the image of the display surface Sim is shifted from an optical axis Z of the projection optical system in a direction perpendicular to the optical axis Z. In the projection optical system including a reflecting surface having a power such as a concave mirror, in the vicinity of the optical axis Z of the image circle, there is a region in which luminous flux is blocked by the projection type display device and cannot be used. Therefore, in most of the projection optical systems, the amount of shift is fixed. In contrast, in a projection optical system that does not include a reflecting surface having a power as in the present disclosure, there is no problem of blocking described above, and the amount of shift can be made variable within the image circle. Therefore, a configuration having a high degree of freedom can be adopted.

The projection optical system of the present disclosure consists of a first optical system G1 and a second optical system G2, in order from the magnification side to the reduction side along the optical path. An intermediate image MI is formed between the first optical system G1 and the second optical system G2. In a case where the focal length of the projection optical system is shortened to achieve an increase in angle of view, in order to achieve optical performance necessary for the projection optical system while ensuring the back focal length necessary for the projection optical system, the size of the lens on the magnification side tends to be increased. By using a relay optical system in which the intermediate image MI is formed, it is possible to shorten the back focal length of the optical system closer to the magnification side than the intermediate image MI, and to reduce the diameter of the lens on the magnification side. As a result, there is an advantage in achieving reduction in size.

The first optical system G1 is configured to include an optical path deflection surface which deflects the optical path. The optical system can be made compact by deflecting the optical path. Therefore, there is an advantage in achieving reduction in size.

For example, the projection optical system of FIG. 1 is configured as follows. The first optical system G1 consists of a front group GIF, a prism Pr, and a rear group G1R, in order from the magnification side to the reduction side. The front group GIF consists of lenses L1a to L1d, in order from the magnification side to the reduction side. The rear group G1R consists of lenses L1e to L1n, in order from the magnification side to the reduction side. The second optical system G2 consists of a lens L2a, a planar mirror Mr, lenses L2b to L2h, an aperture stop St, and lenses L2i to L2m, in order from the magnification side to the reduction side along the optical path. The aperture stop St shown in FIG. 1 does not show the size or the shape thereof, but shows a position thereof in the optical axis direction. The method of showing the aperture stop St is the same in the other drawings. Further, in FIG. 1, the intermediate image MI is conceptually indicated by the dotted line, and the shape of the intermediate image MI in FIG. 1 is not accurate.

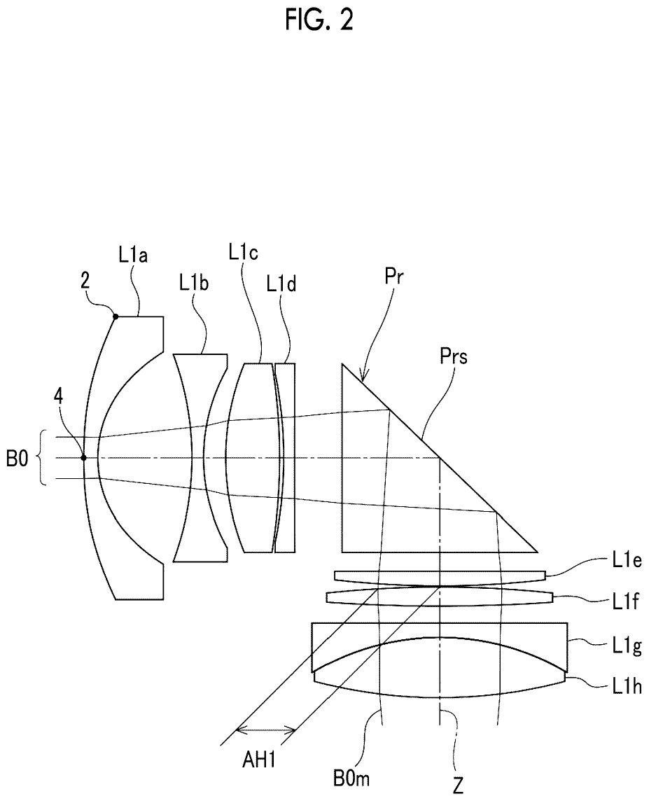

FIG. 2 shows an enlarged view of the prism Pr of the projection optical system of FIG. 1 and the lenses in the vicinity thereof. FIG. 2 shows only the on-axis luminous flux B0. The inside of the prism Pr includes a reflecting surface Prs. The reflecting surface Prs is an example of the optical path deflection surface which deflects the optical path of the present disclosure. The prism Pr is an example of an optical path deflection member of the present disclosure. The optical path deflection surface is the surface of the prism Pr. Therefore, there is an advantage in ensuring the performance during assembly. It should be noted that the surface of the prism on which a reflective film is formed may be used as the optical path deflection surface, or the surface of the prism may be used as the optical path deflection surface by using total reflection.

It is preferable that an outermost periphery of an optical effective surface closest to the magnification side in the first optical system G1 is positioned closer to the reduction side in an optical axis direction than an intersection between the optical effective surface and the optical axis Z. In such a case, there is an advantage in correcting distortion.

In the projection optical system of FIG. 1, the optical effective surface closest to the magnification side in the first optical system G1 is on a magnification side surface of the lens L1a. For example, FIG. 2 shows a point 2 on the outermost periphery of the optical effective surface closest to the magnification side in the first optical system G1, and an intersection 4 between the optical effective surface and the optical axis Z. As shown in FIG. 2, the point 2 is positioned closer to the reduction side than the intersection 4 in the optical axis direction.

The “optical effective surface” is usually a mirror-finished surface. In the present specification, the “optical effective surface” of the lens is a surface that includes a surface within an effective diameter through which the ray for imaging passes and that extends toward the radially outer side in the same shape as the surface shape within the effective diameter. The same shape is a surface that has a shape formed on the basis of the same design data. The term “same design data” means that the curvature radii are the same in a case of a spherical shape, means that the aspherical expressions and the aspherical coefficients are the same in a case of an aspherical shape, and means that the free curved surface expressions and the free curved surface coefficients are the same in a case of a free curved surface shape.

It is preferable that a power of the front group GIF is negative and a power of the rear group G1R is positive. The first optical system G1 is configured to consist of a front group GIF that has a negative power, an optical path deflection member, and a rear group G1R that has a positive power, in order from the magnification side to the reduction side. Thereby, there is an advantage in achieving reduction in size while ensuring a wide angle.

It is preferable that the front group GIF includes one or more positive lenses. In such a case, there is an advantage in correcting chromatic aberration and field curvature.

It is preferable that at least a part of the rear group G1R moves along the optical axis Z during focusing. With such a configuration, it is possible to constitute a projection optical system having a focusing function. Further, in such a case, a configuration, in which the front group GIF remains stationary during focusing and the focusing mechanism is not disposed in the front group GIF, can be made. Therefore, there is an advantage in achieving reduction in size of the lens closest to the magnification side. Hereinafter, a group, which moves during focusing, will be referred to as a focusing group. Focusing is performed by moving the focusing group along the optical axis Z.

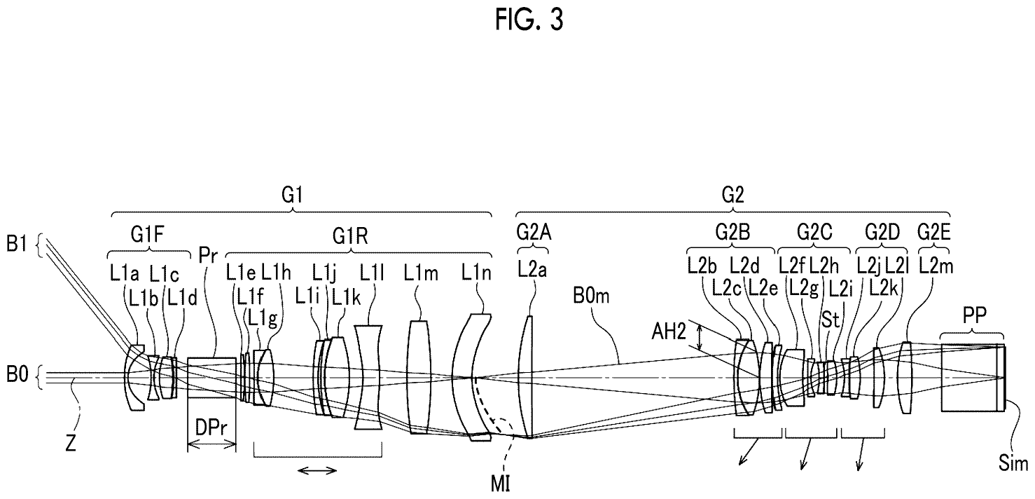

In the example of FIG. 1, the focusing group consists of the lenses L1g to L1l. The brackets and the double-headed arrows attached to the lenses L1g to L1l in FIGS. 1 and 3 indicate that the lenses L1g to L1l are focusing groups. FIG. 3 is a cross-sectional view in which the optical path of the projection optical system of FIG. 1 is expanded. It should be noted that FIG. 3 does not show the reflecting surface Prs, the planar mirror Mr, and the luminous flux B2 with the maximum angle of view.

It is preferable that the second optical system G2 includes two or more movable groups which move along the optical axis Z during magnification change. With such a configuration, it is possible to adopt a configuration of a projection optical system having a zooming function. Further, by disposing the movable group in the second optical system G2 having a relatively small diameter, it is possible to reduce a load on the variable magnification mechanism. Further, since the variable magnification optical system can be configured within the range of the refractive optical system not including the deflected optical path, it is easy to ensure the mechanical accuracy.

It is preferable that the movable group closest to the magnification side among the movable groups of the second optical system G2 has a positive power. In such a case, there is an advantage in achieving reduction in diameter of the movable group closer to the reduction side than the movable group closest to the magnification side. Further, it is easy to ensure a long air spacing closer to the reduction side than the intermediate image MI and closer to the magnification side than the movable group closest to the magnification side. In a case where a member that deflects the optical path is disposed in the long air spacing, the optical path can be deflected twice or more in the entire projection optical system. Thus, there is an advantage in achieving reduction in size thereof. In the second optical system G2 of FIG. 1, the optical path is deflected by 90 degrees by the planar mirror Mr disposed in the long air spacing.

It is preferable that the second optical system G2 includes a stationary group that consists of one positive lens and that remains stationary with respect to the display surface Sim during magnification change, at a position closest to the reduction side. In such a case, it is easy to ensure telecentricity on the reduction side.

For example, as shown in FIG. 3, the second optical system G2 of FIG. 1 includes, in order from the magnification side to the reduction side, five lens groups including a second A lens group G2A, a second B lens group G2B, a second C lens group G2C, a second D lens group G2D, and a second E lens group G2E. Each lens group in FIG. 3 is configured as follows. The second A lens group G2A consists of a lens L2a. The second B lens group G2B consists of lenses L2b to L2e. The second C lens group G2C consists of the lenses L2f to L2h, the aperture stop St, and the lens L2i. The second D lens group G2D consists of lenses L2j to L2l. The second E lens group G2E consists of the lens L2m. During magnification change, the second A lens group G2A and the second E lens group G2E remain stationary with respect to the display surface Sim, and the second B lens group G2B, the second C lens group G2C, and the second D lens group G2D move along the optical axis Z by changing the spacings between the adjacent lens groups. In FIG. 3, brackets and arrows, each indicating an approximate movement direction of each lens group during magnification change from the wide-angle end to the telephoto end, are noted under the lens groups moving during magnification change.

Next, preferable and possible configurations about conditional expressions of the projection optical system according to the present disclosure will be described. In the following description of conditional expressions, in order to avoid redundant descriptions, the same symbols are used for those having the same definition, and duplicate descriptions of the symbols will not be repeated. Further, in the following description, in order to avoid redundant description, the “projection optical system according to the embodiment of the present disclosure” is also simply referred to as a “projection optical system”.

It is preferable that the projection optical system satisfies Conditional Expression (1). Here, it is assumed that a radius of the maximum effective image circle on the reduction side is Imax. It is assumed that a distance on the optical axis from the lens surface closest to the magnification side in the first optical system G1 to the optical path deflection surface is Ddef. Imax is a maximum image height on the reduction side. For example, FIG. 1 shows the radius Imax and the distance Ddef. It is assumed that Ddef is a value at a wide-angle end in a case where the projection optical system is a variable magnification optical system. By not allowing the corresponding value of Conditional Expression (1) to be equal to or less than the lower limit value thereof, it is possible to suppress an increase in size of the lens closest to the magnification side. By not allowing the corresponding value of Conditional Expression (1) to be equal to or greater than the upper limit value thereof, there is an advantage in maintaining favorable optical performance and specifications.

$$0.2 < Imax / Ddef < 0.7 \qquad ( 1 )$$

In order to obtain more favorable characteristics, the lower limit value of Conditional Expression (1) is more preferably 0.25 and yet more preferably 0.3. In order to obtain more favorable characteristics, the upper limit value of Conditional Expression (1) is more preferably 0.6 and yet more preferably 0.5.

It is preferable that the projection optical system satisfies Conditional Expression (2). Here, it is assumed that an average value of Abbe numbers of all negative lenses included in the front group GIF based on the d line is vnave. It is assumed that an average value of Abbe numbers of all the positive lenses included in the front group GIF based on the d line is vpave. By not allowing the corresponding value of Conditional Expression (2) to be equal to or less than the lower limit value thereof, there is an advantage in correcting chromatic aberration. By not allowing the corresponding value of Conditional Expression (2) to be equal to or greater than the upper limit value thereof, there is an advantage in correcting second-order spectrum of chromatic aberration.

$$10 < ν nave - ν pave < 40 \qquad ( 2 )$$

In order to obtain more favorable characteristics, the lower limit value of Conditional Expression (2) is more preferably 12 and yet more preferably 15. In order to obtain more favorable characteristics, the upper limit value of Conditional Expression (2) is more preferably 36 and yet more preferably 32.

It is preferable that the projection optical system satisfies Conditional Expression (3). Here, it is assumed that an average value of refractive indexes of all negative lenses included in the front group GIF at the d line is Nnave. It is assumed that an average value of refractive indexes of all positive lenses included in the front group GIF at the d line is Npave. By not allowing a corresponding value of Conditional Expression (3) to be equal to or less than the lower limit value thereof, there is an advantage in correcting field curvature. By not allowing the corresponding value of Conditional Expression (3) to be equal to or greater than the upper limit value thereof, there is an advantage in correcting spherical aberration.

$$0.15 < Npave - Nnave < 0.45 \qquad ( 3 )$$

In order to obtain more favorable characteristics, the lower limit value of Conditional Expression (3) is more preferably 0.18 and yet more preferably 0.2. In order to obtain more favorable characteristics, the upper limit value of Conditional Expression (3) is more preferably 0.36, and yet more preferably 0.3.

It is preferable that the projection optical system satisfies Conditional Expression (4). Here, it is assumed that an air conversion distance on the optical axis from a surface closest to the reduction side in the front group GIF to a surface closest to the magnification side in the rear group G1R is Dfr. It is should be noted that Dfr is a value at a wide-angle end in a case where the projection optical system is a variable magnification optical system. Conditional Expression (4) is an expression that defines a ratio of a maximum image height on the reduction side to a space in which the optical path deflection member is disposed. According to Conditional Expression (4), a diameter of luminous flux in the optical path deflection member can be suppressed. By not allowing the corresponding value of Conditional Expression (4) to be equal to or less than the lower limit value thereof, it is possible to suppress an increase in size of the lens closest to the magnification side. By not allowing the corresponding value of Conditional Expression (4) to be equal to or greater than the upper limit value thereof, it is possible to ensure a space for passing the luminous flux of which the optical path is deflected.

$$0.5 < Imax / Dfr < 0.9 \qquad ( 4 )$$

In order to obtain more favorable characteristics, it is more preferable that the lower limit value of Conditional Expression (4) is 0.6. In order to obtain more favorable characteristics, it is more preferable that the upper limit value of Conditional Expression (4) is 0.8.

It is preferable that the projection optical system satisfies Conditional Expression (5). Here, it is assumed that a thickness of the prism Pr along the optical axis Z is Dpr. It is assumed that a refractive index of the prism Pr at the d line is Npr. For example, FIG. 3 shows the thickness Dpr. Conditional Expression (5) is an expression that defines a ratio of the maximum image height on the reduction side to the air-equivalent thickness of the prism Pr. By not allowing the corresponding value of Conditional Expression (5) to be equal to or less than the lower limit value thereof, it is possible to suppress an increase in size of the lens closest to the magnification side. By not allowing the corresponding value of Conditional Expression (5) to be equal to or greater than the upper limit value thereof, it is possible to ensure a space for passing the luminous flux of which the optical path is deflected.

$$0.9 < Imax / ( Dpr / Npr ) < 1.3 \qquad ( 5 )$$

In order to obtain more favorable characteristics, it is more preferable that the lower limit value of Conditional Expression (5) is 1. In order to obtain more favorable characteristics, it is more preferable that the upper limit value of Conditional Expression (5) is 1.2.

It is preferable that the projection optical system satisfies Conditional Expression (6). Here, it is assumed that a maximum effective radius of the lens surface closest to the magnification side in the first optical system G1 is ERf. It is assumed that a maximum value of maximum effective radii of all lens surfaces of the projection optical system is ERmax. Regarding the lower limit value of Conditional Expression (6), since ERf>0 and ERmax>0, ERf/ERmax>0. By not allowing the corresponding value of Conditional Expression (6) to be equal to or greater than the upper limit value thereof, it is possible to suppress an increase in size of the lens closest to the magnification side, or there is an advantage in correcting off-axis aberration.

$$0 < ERf / ERmax < 0.7 \qquad ( 6 )$$

In order to obtain more favorable characteristics, it is more preferable that the upper limit value of Conditional Expression (6) is 0.6.

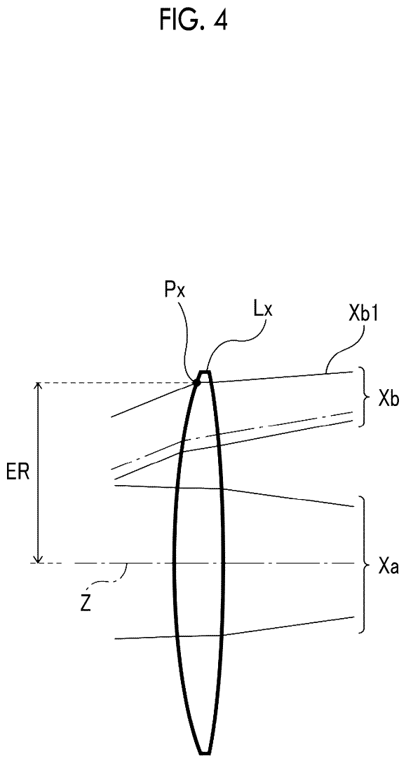

The maximum effective radius will be described with reference to FIG. 4. FIG. 4 is a diagram for explaining. In FIG. 4, the left side is the magnification side and the right side is the reduction side. FIG. 4 shows an on-axis luminous flux Xa and an off-axis luminous flux Xb passing through the lens Lx. In the example of FIG. 4, a ray Xb1, which is the upper ray of the off-axis luminous flux Xb, is the ray passing through the outermost side. The “outer side” here is the radial outside centered on the optical axis Z, that is, the side separated from the optical axis Z. In the present specification, a distance from a position Px of the intersection between the lens surface and the ray passing through the outermost side to the optical axis Z is a maximum effective radius ER of the lens surface. In addition, in the example of FIG. 4, the upper ray of the off-axis luminous flux Xb is the ray passing through the outermost side, but which ray is the ray passing through the outermost side depends on the optical system.

In the example of FIG. 3 in which Conditional Expression (6) is satisfied, a diameter of the lens closest to the magnification side is smaller than a diameter of a lens in a intermediate portion of the projection optical system. Normally, in the projection optical system, the diameter of the lens closest to the magnification side is large. However, in the example of FIG. 3, reduction in diameter of the lens closest to the magnification side is suitably achieved.

It is preferable that the projection optical system satisfies Conditional Expression (7). Here, it is assumed that a maximum value of a height of the on-axis marginal ray B0m from the optical axis Z on all lens surfaces of the first optical system G1 is AH1. It is assumed that a maximum value of a height of the on-axis marginal ray B0m from the optical axis Z in all lens surfaces of the second optical system G2 is AH2. For example, in the projection optical system of FIG. 1, the height of the on-axis marginal ray B0m on the magnification side surface of the lens L1f from the optical axis Z is AH1, and the height of the on-axis marginal ray B0m from the optical axis Z on the reduction side surface of the lens L2c is AH2. FIG. 2 shows the maximum value AH1, and FIG. 3 shows the maximum value AH2. In a case where the projection optical system is a variable magnification optical system, AH1 and AH2 are maximum values in the entire magnification change range. Regarding the lower limit value of Conditional Expression (7), since AH1>0 and AH2>0, AH1/AH2>0. By not allowing the corresponding value of Conditional Expression (7) to be equal to or greater than the upper limit value thereof, it is possible to suppress the expansion of the luminous flux width in the vicinity of the optical path deflection surface. Therefore, it is possible to suppress an increase in size of the lens closest to the magnification side.

$$0 < AH 1 / AH 2 < 0.7 \qquad ( 7 )$$

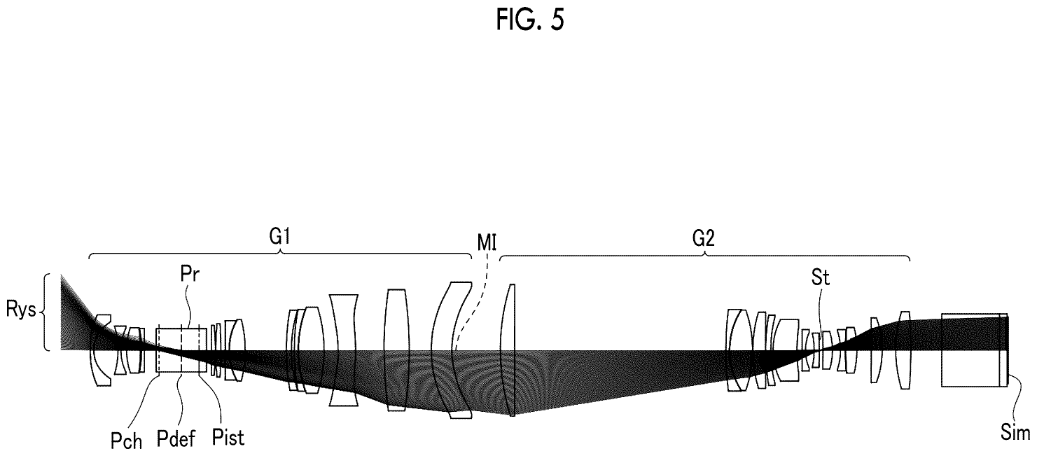

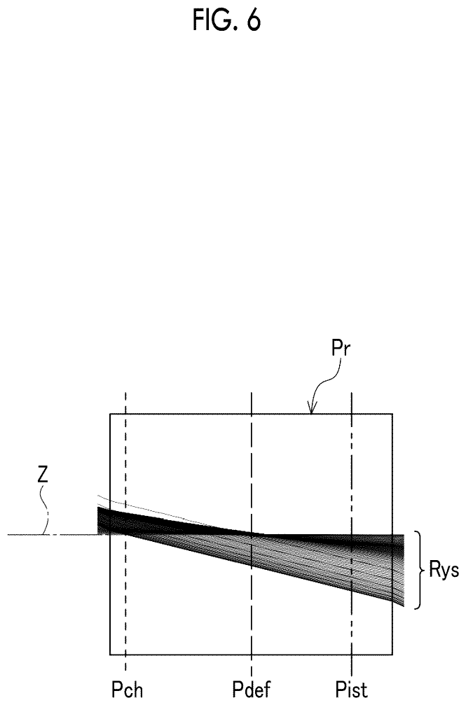

Next, a preferable position, at which the optical path deflection surface is disposed, will be described with reference to FIGS. 5 and 6. For case of understanding, FIG. 5 shows a diagram in which the optical path is developed to be a linear optical path. FIG. 6 is an enlarged view of a part of the prism Pr. In a case where the projection optical system includes the aperture stop St closer to the reduction side than the intermediate image MI and the real image of the aperture stop St is present inside the first optical system G1, it is preferable that a position of the optical path deflection surface is as follows. Here, a position of the real image of the aperture stop St in the optical axis direction is set as a position Pist. A position farthest from the position Pist is set as a position Pch, among positions where a ray, which is emitted from an optional point in a maximum effective image circle on the reduction side and which passes through a center of the aperture stop St toward the magnification side, intersects the optical axis Z at a position closer to the magnification side than the intermediate image MI. It is preferable that the intersection between the optical path deflection surface and the optical axis Z is positioned within a range from the position Pist to the position Pch in the optical axis direction. In such a case, the optical path deflection surface can be disposed in the vicinity of the real image of the pupil. In a case where the projection optical system is a variable magnification optical system, it is preferable that the intersection between the optical path deflection surface and the optical axis Z is positioned within the above-mentioned range at the wide-angle end.

For example, in FIGS. 5 and 6, a two-dot chain line indicates the position Pist in the projection optical system of FIG. 1, a short broken line indicates the position Pch, and a long broken line indicates the position Pdef of the intersection between the optical path deflection surface and the optical axis Z. In addition, FIGS. 5 and 6 show the positions in the optical axis direction. FIGS. 5 and 6 also show a large number of rays Rys that are emitted from a large number of points within the maximum effective image circle on the reduction side and that pass through the center of the aperture stop St toward the magnification side. In the projection optical system of FIG. 1, all the three positions are positioned inside the prism Pr which is the optical path deflection member.

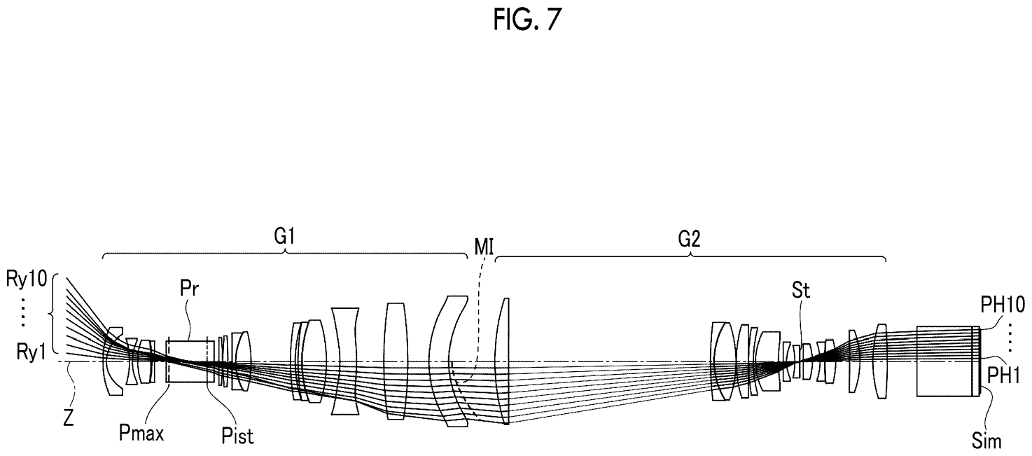

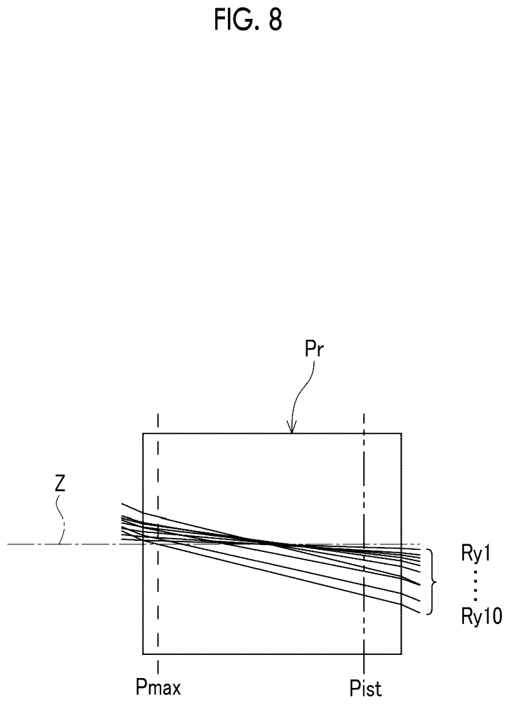

Regarding the position Pist, it is preferable that the projection optical system satisfies Conditional Expression (8). Conditional Expression (8) will be described with reference to FIGS. 7 and 8. For case of understanding, FIG. 7 shows a diagram in which the optical path is developed to be a linear optical path. FIG. 8 shows an enlarged view of a part of the prism Pr. Here, it is assumed that a natural number of 1 to 10 is k. That is, k=1, 2, 3, 4, 5, 6, 7, 8, 9, and 10. Then, it is assumed that a point, of which a height from the optical axis Z on the maximum effective image circle on the reduction side is a height of k tenths of a radius Imax of the maximum effective image circle, is a point PHk. It is assumed that a position, at which a ray that is emitted from the point PHk and that passes through the center of the aperture stop St toward the magnification side intersects the optical axis Z at the position closer to the magnification side than the intermediate image MI, is a position Pk. In the position Pk, a position, at which the air conversion distance from the position Pist is longest, is set as a position Pmax. Then, it is assumed that the air conversion distance on the optical axis from the position Pist to the position Pmax is DifP. A sign of DifP is positive at a distance on the reduction side and is negative at a distance on the magnification side, in a case where the position Pist is set as a reference. It is should be noted that DifP is a value at a wide-angle end in a case where the projection optical system is a variable magnification optical system. Conditional Expression (8) is an expression that defines a ratio of the pupil aberration to the maximum image height. By not allowing the corresponding value of Conditional Expression (8) to be equal to or less than the lower limit value thereof, it is possible to suppress an increase in total length of the optical system. By not allowing the corresponding value of Conditional Expression (8) to be equal to or greater than the upper limit value thereof, it is possible to suppress an increase in size of the lens closest to the magnification side.

$$- 3 < DifP / Imax < - 0.2 \qquad ( 8 )$$

In order to obtain more favorable characteristics, it is more preferable that the lower limit value of Conditional Expression (8) is −2.5. In order to obtain more favorable characteristics, it is more preferable that the upper limit value of Conditional Expression (8) is −0.5.

For example, in FIGS. 7 and 8, a two-dot chain line indicates the position Pist in the projection optical system of FIG. 1, and a broken line indicates the position Pmax. In addition, FIGS. 7 and 8 show the positions in the optical axis direction. FIGS. 7 and 8 also show ten rays Ry1, . . . , Ry10, that are emitted from the point PHk, of which the height from the optical axis Z on the maximum effective image circle on the reduction side is the height of k tenths of the radius Imax of the maximum effective image circle, and that pass through the center of the aperture stop St toward the magnification side. In FIG. 7, in order to avoid complication of the drawing, only the point PH1 and the point PH10 are represented by reference numerals among the points PHk. In the projection optical system of FIG. 1, the position Pist, and the position Pmax are positioned within the prism Pr which is the optical path deflection member.

Further, regarding the DifP, it is preferable that the projection optical system satisfies Conditional Expression (9). Conditional Expression (9) is an expression that defines the ratio of the pupil aberration to the space in which the optical path deflection member is disposed. According to Conditional Expression (9), a diameter of luminous flux in the optical path deflection member can be suppressed. By not allowing the corresponding value of Conditional Expression (9) to be equal to or less than the lower limit value thereof, it is possible to suppress an increase in size of the lens closest to the magnification side. By not allowing the corresponding value of Conditional Expression (9) to be equal to or greater than the upper limit value thereof, it is possible to ensure a space for passing the luminous flux of which the optical path is deflected.

$$0.4 < \vert DifP / Dfr \vert < 0. 7 \qquad ( 9 )$$

In order to obtain more favorable characteristics, it is more preferable that the lower limit value of Conditional Expression (9) is 0.45. In order to obtain more favorable characteristics, it is more preferable that the upper limit value of Conditional Expression (9) is 0.6.

It is preferable that the projection optical system satisfies Conditional Expression (10). Conditional Expression (10) is an expression that defines the ratio of the pupil aberration to the air-equivalent thickness of the prism Pr. By not allowing the corresponding value of Conditional Expression (10) to be equal to or less than the lower limit value thereof, it is possible to suppress an increase in size of the lens closest to the magnification side. By not allowing the corresponding value of Conditional Expression (10) to be equal to or greater than the upper limit value thereof, it is possible to ensure a space for passing the luminous flux of which the optical path is deflected.

$$0.7 < \vert DifP / ( Dpr / Npr ) \vert < 1. 8 \qquad ( 10 )$$

In order to obtain more favorable characteristics, it is more preferable that the lower limit value of Conditional Expression (10) is 0.75. In order to obtain more favorable characteristics, it is more preferable that the upper limit value of Conditional Expression (10) is 1.2.

The example shown in FIG. 1 is an example, and various modifications can be made without departing from the scope of the technique according to the embodiment of the present disclosure. For example, the number of lenses included in each optical system and the shapes of the lenses may be different from those in the example of FIG. 1. In the example of FIG. 1, all the optical elements having powers are refractive elements, but the projection optical system of the present disclosure may include a diffractive optical element.

The optical path deflection surface may be a surface of a reflection mirror. In such a case, there is an advantage in achieving reduction in weight. The reflection mirror may be a metal mirror or a dielectric multi-layer film mirror. Further, the number of optical path deflection surfaces included in the projection optical system can be set to any number. The angle at which the optical path deflection surface deflects the optical path is 90 degrees. As a result, there is an advantage in manufacturing, but may be other than 90 degrees. It should be noted that the term “90 degrees” includes an error that is practically allowed in the technical field to which the technique of the present disclosure belongs. The error can be, for example, in a range of −1 degree or more and +1 degree or less.

The above-mentioned preferred configurations and available configurations including the configurations relating to Conditional Expressions may be any combination, and it is preferable to appropriately and selectively adopt the configurations in accordance with necessary specification.

For example, according to a preferable aspect of the present disclosure, there is provided a projection optical system that projects an image on a reduction side to a magnification side. The projection optical system does not include a reflecting surface having a power. The projection optical system consists of, in order from the magnification side to the reduction side along the optical path, the first optical system G1 and the second optical system G2. The intermediate image MI is formed between the first optical system G1 and the second optical system G2. The first optical system G1 includes the optical path deflection surface which deflects the optical path. Then, Conditional Expression (1) is satisfied.

Next, examples of the projection optical system according to the present disclosure will be described, with reference to the drawings. The reference numerals noted in the cross-sectional views of each example are used independently for each example in order to avoid complication of description and drawings due to an increase in number of digits of the reference numerals. Therefore, even in a case where common reference numerals are attached in the drawings of different examples, components do not necessarily have a common configuration.

### Example 1

FIG. 1 is a cross-sectional view of a configuration and luminous flux of a projection optical system of Example 1, and an illustration method and a configuration thereof are as described above. Therefore, some description is not repeated herein. The projection optical system of Example 1 consists of a first optical system G1 and a second optical system G2, in order from the magnification side to the reduction side along the optical path. An intermediate image MI is formed between the first optical system G1 and the second optical system G2. The first optical system G1 includes a prism Pr inside. The prism Pr has a reflecting surface Prs, and the reflecting surface Prs functions as an optical path deflection surface which deflects the optical path by 90 degrees. The second optical system G2 includes five lens groups. Three lens groups among the five lens groups move by changing the spacing between the adjacent lens groups during magnification change. The second optical system G2 includes a planar mirror Mr which deflects the optical path by 90 degrees.

Regarding the projection optical system of Example 1, Tables 1A and 1B show basic lens data, Table 2 shows specifications and variable surface spacings, and Table 3 shows aspherical coefficients. Here, the basic lens data is shown to be divided into two tables including Tables 1A and 1B, in order to avoid an increase in length of one table. Table 1A shows the first optical system G1 and Table 1B shows the second optical system G2.

The table of basic lens data will be described as follows. The Sn column shows surface numbers in a case where the surface closest to the magnification side is the first surface and the number is increased one by one toward the reduction side. However, “Prs” is noted in the surface number column of the surface corresponding to the reflecting surface Prs, and “Mr” is noted in the surface number column of the surface corresponding to the planar mirror Mr. Further, the surface number and “(St)” are noted in the surface number column of the surface corresponding to the aperture stop St. The R column shows a curvature radius of each surface. The D column shows a surface spacing between each surface and the surface adjacent to the reduction side on the optical axis. The Nd column shows a refractive index of each component at the d line. The vd column shows an Abbe number of each component based on the d line. The ER column shows a maximum effective radius of each surface. The AH column shows a height of the on-axis marginal ray B0m of each surface from the optical axis Z. The values shown in the AH column are the maximum values in the entire magnification change range.

In the table of the basic lens data, the sign of the curvature radius of the convex surface facing toward the magnification side is positive, and the sign of the curvature radius of the convex surface facing toward the reduction side is negative. In the table of basic lens data, the symbol DD [ ] is used for each variable surface spacing during magnification change, and the magnification side surface number of the spacing is given in [ ] and is noted in the D column.

Table 2 shows the magnification change ratio Zr, the absolute value |f| of the focal length, the back focal length Bf in terms of the air conversion distance, the F number FNo., the maximum total angle of view 2ω, and the variable surface spacing, based on the d line. [°] in the cells of 2ω indicates that the unit thereof is a degree. In Table 2, the values in the wide-angle end state and the telephoto end state are shown in the columns labeled “Wide” and “Tele”, respectively.

In basic lens data, a reference sign * is attached to surface numbers of aspherical surfaces, and values of the paraxial curvature radius are written into the column of the curvature radius of the aspherical surface. In Table 3, the row of Sn shows surface numbers of the aspherical surfaces, and the rows of KA and Am (m=3, 4, 5, 6, . . . , 20) show numerical values of the aspherical coefficients for each aspherical surface. The “E±n” (n: an integer) in numerical values of the aspherical coefficients of Table 3 indicates “×10^{±n}”. KA and Am are the aspherical coefficients in the aspherical expression represented by the following expression.

$$Zd = C \times {h}^{2} / \{ 1 + {( 1 - KA \times {C}^{2} \times {h}^{2} )}^{1 / 2} \} + \sum Am \times {h}^{m}$$

Here,
Zd is an aspherical surface depth (a length of a perpendicular from a point on an aspherical surface at height h to a plane that is perpendicular to the optical axis Z and that is in contact with the vertex of the aspherical surface),
h is a height (a distance from the optical axis Z to the lens surface),
C is a reciprocal of the paraxial curvature radius,
KA and Am are aspherical coefficients, and
Σ in the aspherical expression means the sum with respect to m.

In the data of each table, degrees are used as a unit of an angle, and millimeters (mm) are used as a unit of a length, but appropriate different units may be used since the optical system can be used even in a case where the system is enlarged or reduced in proportion. Further, each of the following tables shows numerical values rounded off to predetermined decimal places.

TABLE 1A
Example 1

| Sn | R | D | Nd | νd | ER | AH |
|---|---|---|---|---|---|---|
| *1 | 55.4661 | 1.4326 | 1.85135 | 40.10 | 14.000 | 2.331 |
| *2 | 13.0558 | 9.6112 | | | 10.583 | 2.298 |
| 3 | −32.5700 | 1.1781 | 1.43700 | 95.10 | 9.484 | 3.418 |
| 4 | 19.9925 | 2.2649 | | | 8.795 | 3.615 |
| 5 | 27.2753 | 5.4996 | 1.86314 | 39.62 | 8.974 | 4.201 |
| 6 | −64.0682 | 0.4229 | | | 8.708 | 4.501 |
| 7 | −46.2386 | 1.0954 | 1.55871 | 46.08 | 8.652 | 4.519 |
| 8 | 1307.5561 | 4.7797 | | | 8.457 | 4.609 |
| 9 | ∞ | 10.0000 | 1.71299 | 53.87 | 7.774 | 5.123 |
| Prs | ∞ | 10.0000 | 1.71299 | 53.87 | — | — |
| 10 | ∞ | 2.0000 | | | 8.500 | 6.376 |
| 11 | ∞ | 1.5429 | 1.84850 | 43.79 | 9.578 | 6.592 |
| 12 | −90.1791 | 0.1205 | | | 9.844 | 6.667 |
| 13 | 104.2212 | 2.0349 | 1.90265 | 35.77 | 10.324 | 6.693 |
| 14 | −160.5365 | 1.8050 | | | 10.501 | 6.681 |
| 15 | −12636.1009 | 1.5152 | 1.77561 | 32.21 | 10.993 | 6.579 |
| 16 | 24.4442 | 6.4041 | 1.59282 | 68.62 | 11.558 | 6.509 |
| 17 | −47.6438 | 16.3917 | | | 11.980 | 6.508 |
| 18 | 90.0046 | 1.9995 | 1.83897 | 25.48 | 15.633 | 5.093 |
| 19 | 51.6637 | 1.1605 | | | 15.689 | 4.944 |
| 20 | 87.2454 | 1.6306 | 1.76650 | 27.90 | 15.741 | 4.891 |
| 21 | 47.5342 | 10.2174 | 1.52841 | 76.45 | 16.031 | 4.800 |
| 22 | −57.2897 | 5.6282 | | | 16.880 | 4.359 |
| *23 | −43.3566 | 6.9499 | 1.51623 | 64.05 | 17.495 | 3.139 |
| *24 | −63.4052 | 11.3084 | | | 18.791 | 3.434 |
| 25 | 167.8508 | 10.0000 | 1.90996 | 19.46 | 23.273 | 2.376 |
| 26 | −164.8461 | 8.8085 | | | 23.951 | 1.828 |
| *27 | 46.1822 | 8.1977 | 1.51007 | 56.24 | 25.038 | 0.801 |
| *28 | 40.5431 | 19.2956 | | | 24.013 | 0.130 |

TABLE 1B
Example 1

| Sn | R | D | Nd | νd | ER | AH |
|---|---|---|---|---|---|---|
| 29 | 86.6404 | 5.6681 | 1.91001 | 36.51 | 25.991 | 2.273 |
| 30 | 5524.0670 | 34.7570 | | | 25.873 | 2.565 |
| Mr | ∞ | DD[30] | | | — | — |
| 31 | 129.8877 | 1.5106 | 1.51860 | 69.89 | 16.109 | 10.361 |
| 32 | 29.7122 | 9.1201 | 1.43700 | 95.10 | 15.911 | 10.464 |
| 33 | −47.8171 | 0.1203 | | | 15.903 | 10.812 |
| 34 | 51.3729 | 5.0098 | 1.80809 | 22.74 | 15.044 | 10.768 |
| 35 | 1166.9307 | 0.1000 | | | 14.390 | 10.355 |
| 36 | 80.4971 | 1.9990 | 1.61212 | 36.74 | 13.867 | 10.224 |
| 37 | 51.6449 | DD[37] | | | 13.055 | 9.848 |
| 38 | 25.9182 | 9.5222 | 1.72846 | 55.03 | 12.166 | 9.584 |
| 39 | 63.1918 | 2.0324 | | | 9.086 | 7.557 |
| 40 | −24139.9598 | 1.3556 | 1.67361 | 32.11 | 8.117 | 7.003 |
| 41 | 17.0824 | 3.4448 | | | 7.065 | 6.474 |
| 42 | −30.2900 | 1.9991 | 1.84648 | 24.12 | 6.709 | 6.377 |
| 43 | −255.3679 | 0.1000 | | | 6.581 | 6.542 |
| 44(St) | ∞ | 1.4366 | | | 6.560 | 6.560 |
| 45 | −464.6426 | 3.7641 | 1.80817 | 48.65 | 6.939 | 6.109 |
| 46 | −25.0208 | DD[46] | | | 7.357 | 6.895 |
| 47 | −23.8127 | 1.8860 | 1.89286 | 20.36 | 7.503 | 6.452 |
| 48 | 88.6952 | 0.2234 | | | 8.097 | 6.659 |
| 49 | 112.9907 | 4.4054 | 1.43875 | 94.66 | 8.163 | 6.694 |
| 50 | −37.2521 | 5.1522 | | | 8.975 | 7.118 |
| 51 | −1270.9380 | 4.3323 | 1.81110 | 28.65 | 12.103 | 7.685 |
| 52 | −36.2710 | DD[52] | | | 12.718 | 7.864 |
| 53 | 52.2089 | 5.9995 | 1.72916 | 54.61 | 15.389 | 7.258 |
| 54 | −186.0535 | 12.3352 | | | 15.368 | 6.663 |
| 55 | ∞ | 23.0000 | 1.51633 | 64.14 | 14.426 | 3.888 |
| 56 | ∞ | 3.0000 | 1.48749 | 70.44 | 13.327 | 0.560 |
| 57 | ∞ | 0.5049 | | | 13.184 | 0.117 |

TABLE 2
Example 1

| | Wide | Tele |
|---|---|---|
| Zr | 1.00 | 1.15 |
| \|f\| | 10.26 | 11.80 |
| Bf | 29.96 | 29.94 |
| FNo. | 2.3 | 2.5 |
| 2ω[°] | 104.4 | 96.6 |
| DD[301 | 49.14 | 40.73 |
| DD[37] | 0.92 | 1.22 |
| DD[46] | 3.21 | 5.22 |
| DD[52] | 5.41 | 11.52 |

TABLE 3
Example 1

| Sn | 1 | 2 | 23 | 24 |
|---|---|---|---|---|
| KA | 1.0000000E+00 | 1.0000000E+00 | 1.0000000E+00 | 1.0000000E+00 |
| A3 | −2.4593902E-04 | −1.5584110E−04 | −1.0968426E−05 | −3.8343722E−05 |
| A4 | 2.4332496E−04 | 2.5981924E−04 | 6.2879283E−06 | 3.4681362E−05 |
| A5 | −1.0572463E−05 | −1.7860592E−05 | 2.9621638E−06 | −2.7033865E−06 |
| A6 | −5.3949936E−06 | −8.3491770E−06 | 2.6161942E−08 | 5.0981941E−07 |
| A7 | 5.9098467E−07 | 1.8611166E−06 | −4.0955743E−08 | 2.1842210E−10 |
| A8 | 5.0533088E−08 | −1.9060062E−08 | 4.7147176E−10 | −7.9044432E−09 |
| A9 | −9.9523006E−09 | −4.6162863E−08 | 3.2504256E−10 | 3.9829721E−10 |
| A10 | −8.2327068E−11 | 5.5308896E−09 | −5.9777206E−12 | 4.7083609E−11 |
| A11 | 8.3062404E−11 | 3.6762772E−10 | −1.6934531E−12 | −3.8499584E−12 |
| A12 | −2.0368362E−12 | −1.1394439E−10 | 3.9096192E−14 | −1.1715551E−13 |
| A13 | −3.8107237E−13 | 2.6335832E−12 | 5.5493626E−15 | 1.6412310E−14 |
| A14 | 1.7076147E−14 | 9.9570558E−13 | −1.5362499E−16 | 1.5851739E−17 |
| A15 | 9.5012085E−16 | −6.7135567E−14 | −1.0757647E−17 | −3.6275704E−17 |
| A16 | −5.9337785E−17 | −3.3698633E−15 | 3.4028375E−19 | 4.9449822E−19 |
| A17 | −1.1308829E−18 | 4.3383214E−16 | 1.1165761E−20 | 4.0568931E−20 |
| A18 | 9.7332939E−20 | −2.3130246E−18 | −3.8624133E−22 | −9.0400917E−22 |
| A19 | 4.0583938E−22 | −9.5984432E−19 | −4.7608019E−24 | −1.8166065E−23 |
| A20 | −6.0219046E−23 | 2.7977393E−20 | 1.7367763E−25 | 5.0923109E−25 |

| Sn | 27 | 28 |
|---|---|---|
| KA | 1.0000000E+00 | 1.0000000E+00 |
| A3 | 2.4369099E−04 | 1.0637544E−03 |
| A4 | −5.1802200E−05 | −1.3632167E−04 |
| A5 | 2.0802070E−06 | −6.8692714E−06 |
| A6 | 3.0408678E−07 | 1.8230914E−06 |
| A7 | −1.7673594E−08 | −3.1543679E−09 |
| A8 | −1.3249198E−09 | −1.1480385E−08 |
| A9 | 6.1107858E−11 | 2.1124449E−10 |
| A10 | 4.6781038E−12 | 4.0231747E−11 |
| A11 | −1.2051446E−13 | −9.6597569E−13 |
| A12 | −1.1943463E−14 | −8.5307476E−14 |
| A13 | 1.5446305E−16 | 2.0959335E−15 |
| A14 | 1.9795275E−17 | 1.1249126E−16 |
| A15 | −1.3534868E−19 | −2.4629487E−18 |
| A16 | −1.9825578E−20 | −9.0535997E−20 |
| A17 | 7.4116501E−23 | 1.5051303E−21 |
| A18 | 1.0838744E−23 | 4.0818345E−23 |
| A19 | −1.8376356E−26 | −3.7437512E−25 |
| A20 | −2.4763175E−27 | −7.9114102E−27 |

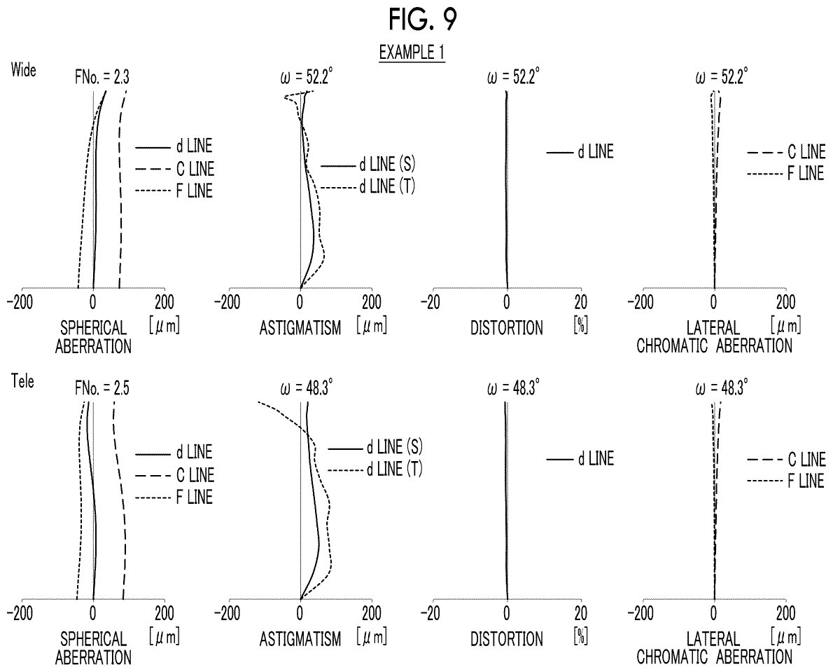

FIG. 9 shows a diagram of aberrations in the projection optical system of Example 1 in a state where the projection distance is 1.55 meters (m). The projection distance is a distance on the optical axis from the projection surface to the lens surface closest to the magnification side. FIG. 9 shows, in order from the left, spherical aberration, astigmatism, distortion, and lateral chromatic aberration. In the spherical aberration diagram, aberrations at the d line, C line, and F line are indicated by the solid line, the long broken line, and the short broken line, respectively. In the astigmatism diagram, the aberration at the d line in the sagittal direction is indicated by a solid line, and the aberration at the d line in the tangential direction is indicated by the short broken line. In the distortion diagram, aberration at the d line is indicated by the solid line. In the lateral chromatic aberration diagram, aberrations at the C line and the F line are indicated by the long broken line and the short broken line, respectively. In the spherical aberration diagram, the value of the F number is shown after “FNo.=”. In other aberration diagrams, the value of the maximum half angle of view is shown after “ω=”.

Symbols, meanings, description methods, and illustration methods of the respective data pieces according to Example 1 are basically similar to those in the following examples unless otherwise specified. Therefore, in the following description, repeated description will not be given.

### Example 2

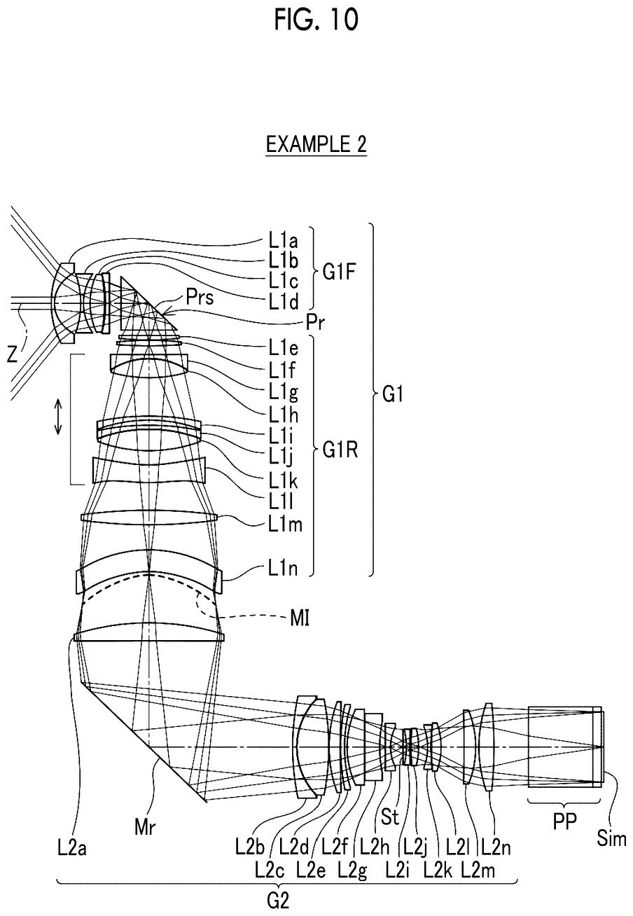

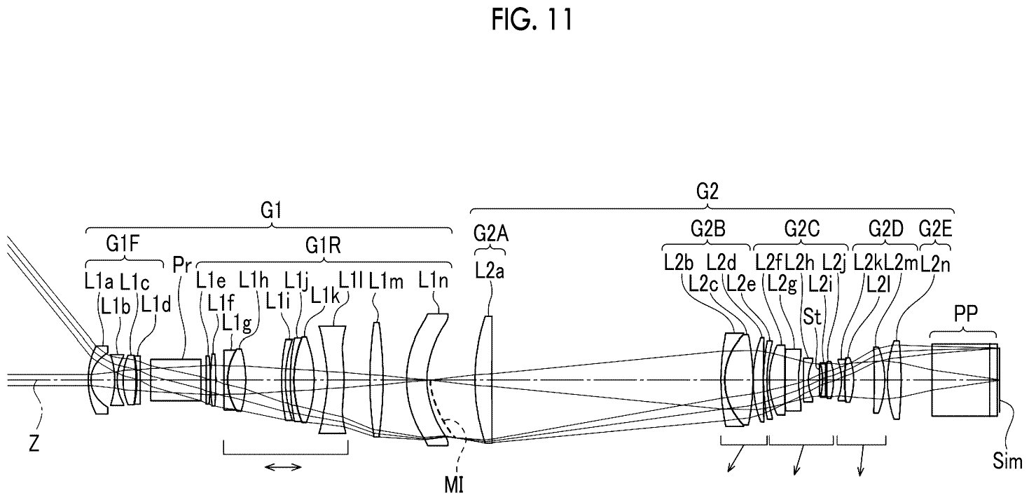

FIG. 10 shows a cross-sectional view of a configuration and luminous flux of a projection optical system of Example 2. FIG. 11 shows a cross-sectional view of the optical path of the projection optical system of Example 2. The projection optical system of Example 2 consists of a first optical system G1 and a second optical system G2, in order from the magnification side to the reduction side along the optical path. An intermediate image MI is formed between the first optical system G1 and the second optical system G2.

The first optical system G1 consists of a front group GIF, a prism Pr, and a rear group G1R, in order from the magnification side to the reduction side along the optical path. The front group GIF consists of lenses L1a to L1d, in order from the magnification side to the reduction side along the optical path. The rear group G1R consists of lenses L1e to L1n, in order from the magnification side to the reduction side along the optical path. A reflecting surface Prs inside the prism Pr functions as an optical path deflection surface which deflects the optical path by 90 degrees. The focusing group consists of lenses L1g to L1l.

The second optical system G2 consists of, in order from the magnification side to the reduction side along the optical path, a second A lens group G2A, a planar mirror Mr, a second B lens group G2B, a second C lens group G2C, a second D lens group G2D, and a second E lens group G2E. The second A lens group G2A consists of a lens L2a. The second B lens group G2B consists of lenses L2b to L2e. The second C lens group G2C consists of lenses L2f to L2h, an aperture stop St, and lenses L2i to L2j. The second D lens group G2D consists of lenses L2k to L2m. The second E lens group G2E consists of lenses L2n. During magnification change, the second A lens group G2A and the second E lens group G2E remain stationary with respect to the display surface Sim, and the second B lens group G2B, the second C lens group G2C, and the second D lens group G2D move along the optical axis Z by changing the spacings between the adjacent lens groups. The planar mirror Mr functions as an optical path deflection surface which deflects an optical path by 90 degrees.

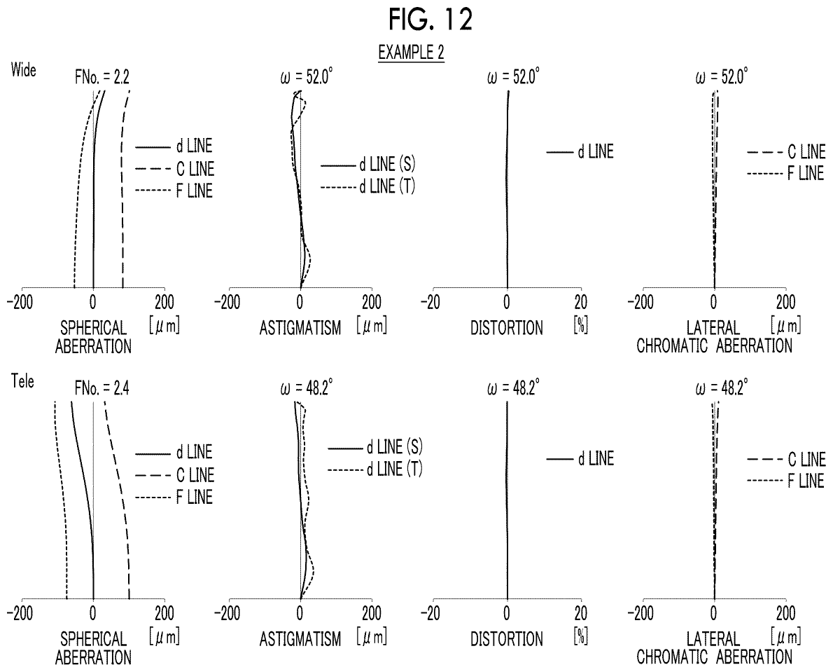

Regarding the projection optical system of Example 2, Tables 4A and 4B show basic lens data, Table 5 shows specifications and variable surface spacings, and Table 6 shows aspherical coefficients thereof. FIG. 12 shows aberration diagrams thereof. The aberration diagrams are in a state where the projection distance is 1.55 meters (m).

TABLE 4A
Example 2

| Sn | R | D | Nd | νd | ER | AH |
|---|---|---|---|---|---|---|
| *1 | 48.4236 | 1.1001 | 1.85135 | 40.10 | 14.000 | 2.443 |
| *2 | 13.0628 | 9.4046 | | | 10.943 | 2.411 |
| 3 | −34.0606 | 1.0001 | 1.44357 | 88.81 | 10.467 | 3.503 |
| 4 | 20.1686 | 2.3467 | | | 10.021 | 3.679 |
| 5 | 26.8039 | 5.1211 | 1.87572 | 39.71 | 10.258 | 4.295 |
| 6 | −64.2992 | 0.4281 | | | 9.980 | 4.553 |
| 7 | −46.3881 | 1.3572 | 1.54626 | 62.35 | 9.926 | 4.569 |
| 8 | −8402.6270 | 4.1608 | | | 9.542 | 4.668 |
| 9 | ∞ | 10.0000 | 1.71299 | 53.87 | 8.500 | 5.072 |
| Prs | ∞ | 10.0000 | 1.71299 | 53.87 | — | — |
| 10 | ∞ | 2.0000 | | | 8.500 | 6.201 |
| 11 | ∞ | 1.7077 | 1.84850 | 43.79 | 9.616 | 6.395 |
| 12 | −91.7061 | 0.1200 | | | 9.934 | 6.472 |
| 13 | 104.9199 | 2.0482 | 1.90265 | 35.77 | 10.438 | 6.492 |
| 14 | −162.6580 | 3.2808 | | | 10.623 | 6.474 |
| 15 | −4952.3799 | 1.5008 | 1.78880 | 28.42 | 11.502 | 6.283 |
| 16 | 24.2648 | 7.1431 | 1.59410 | 60.47 | 12.145 | 6.212 |
| 17 | −47.0946 | 14.3378 | | | 12.653 | 6.202 |
| 18 | 85.5795 | 1.5006 | 1.76079 | 30.28 | 16.413 | 4.970 |
| 19 | 51.1078 | 1.9140 | | | 16.494 | 4.856 |
| 20 | 85.4665 | 1.5001 | 1.88236 | 30.25 | 16.795 | 4.158 |
| 21 | 49.1983 | 8.0260 | 1.52731 | 75.16 | 17.018 | 4.670 |
| 22 | −50.5847 | 5.3003 | | | 17.385 | 4.322 |
| *23 | −43.8618 | 6.6221 | 1.51623 | 64.05 | 17.988 | 3.102 |
| *24 | −60.7351 | 10.3192 | | | 19.211 | 3.380 |
| 25 | 173.0631 | 5.2008 | 1.91000 | 19.46 | 23.208 | 2.329 |
| 26 | −171.6878 | 9.3727 | | | 23.411 | 2.025 |
| *27 | 43.9674 | 8.1188 | 1.51007 | 56.24 | 24.596 | 0.855 |
| *28 | 38.7487 | 19.1475 | | | 23.431 | 0.142 |

TABLE 4B
Example 2

| Sn | R | D | Nd | νd | ER | AH |
|---|---|---|---|---|---|---|
| 29 | 84.5114 | 6.7423 | 1.87140 | 24.81 | 25.889 | 2.420 |
| 30 | 4988.0432 | 39.7070 | | | 25.737 | 2.801 |
| Mr | ∞ | DD[30] | | | — | — |
| 31 | 95.1999 | 1.5009 | 1.57099 | 50.80 | 19.097 | 11.966 |
| 32 | 26.6600 | 11.1982 | 1.55032 | 75.50 | 18.457 | 12.031 |
| 33 | −97.1306 | 0.1202 | | | 18.294 | 12.221 |
| 34 | 51.0227 | 4.0252 | 1.91000 | 36.31 | 17.132 | 12.147 |
| 35 | 543.6240 | 0.1000 | | | 16.742 | 11.792 |
| 36 | 84.4754 | 1.3798 | 1.48750 | 61.11 | 15.944 | 11.608 |
| 37 | 55.8501 | DD[37] | | | 15.179 | 11.255 |
| 38 | 34.7378 | 6.1641 | 1.88972 | 31.91 | 14.159 | 10.936 |
| 39 | 3356.6178 | 0.1647 | | | 12.744 | 9.773 |
| 40 | 1399.7529 | 5.3163 | 1.85451 | 25.15 | 12.509 | 9.672 |
| 41 | 51.6937 | 2.0324 | | | 9.674 | 8.069 |
| 42 | −843.4900 | 1.8530 | 1.63984 | 36.51 | 8.877 | 7.558 |
| 43 | 17.2426 | 4.4449 | | | 7.489 | 6.849 |
| 44(St) | ∞ | 1.2200 | | | 6.604 | 6.604 |
| 45 | −28.0717 | 1.2002 | 1.76203 | 26.89 | 6.665 | 6.573 |
| 46 | 333.1824 | 0.4862 | | | 7.055 | 6.707 |
| 47 | 149.2192 | 2.6801 | 1.79350 | 50.13 | 7.270 | 6.183 |
| 48 | −27.8054 | DD[48] | | | 7.520 | 6.870 |
| 49 | −22.6796 | 1.2004 | 1.89286 | 20.36 | 7.894 | 6.458 |
| 50 | 88.6952 | 0.1845 | | | 8.545 | 6.645 |
| 51 | 112.9907 | 3.4344 | 1.43875 | 94.66 | 8.602 | 6.675 |
| 52 | −27.8000 | 8.2045 | | | 9.127 | 6.988 |
| 53 | −490.6920 | 4.1713 | 1.88144 | 24.70 | 13.180 | 7.104 |
| 54 | −38.2290 | DD[54] | | | 13.705 | 7.873 |
| 55 | 52.0708 | 5.4090 | 1.69560 | 59.05 | 16.287 | 7.634 |
| 56 | −166.5303 | 12.3352 | | | 16.251 | 7.085 |
| 57 | ∞ | 23.0000 | 1.51633 | 64.14 | 14.943 | 4.171 |
| 58 | ∞ | 3.0000 | 1.48749 | 70.44 | 13.439 | 0.687 |
| 59 | ∞ | 0.9514 | | | 13.239 | 0.224 |

TABLE 5
Example 2

| | Wide | Tele |
|---|---|---|
| Zr | 1.00 | 1.15 |
| \|f\| | 10.25 | 11.79 |
| Bf | 30.40 | 30.38 |
| FNo. | 2.2 | 2.4 |
| 2ω[°] | 104.0 | 96.4 |
| DD[30] | 51.32 | 42.81 |
| DD[37] | 0.94 | 1.38 |
| DD[48] | 3.21 | 5.36 |
| DD[54] | 1.13 | 7.06 |

TABLE 6
Example 2

| Sn | 1 | 2 | 23 | 24 |
|---|---|---|---|---|
| KA | 1.0000000E+00 | 1.0000000E+00 | 1.0000000E+00 | 1.0000000E+00 |
| A3 | −2.4395674E−04 | −2.0636963E−04 | −9.6774835E−06 | −3.6872622E−05 |
| A4 | 2.4102913E−04 | 2.5095320E−04 | 7.7452762E−06 | 3.4068742E−05 |
| A5 | −1.0498608E−05 | −1.4070929E−05 | 2.9186023E−06 | −2.6922482E−06 |
| A6 | −5.3405823E−06 | −8.1075050E−06 | −3.0821221E−11 | 5.2069539E−07 |
| A7 | 5.8534489E−07 | 1.6958391E−06 | −4.0497421E−08 | −2.7640254E−10 |
| A8 | 4.9714033E−08 | −1.9339357E−08 | 7.6074809E−10 | −8.0171753E−09 |
| A9 | −9.8261705E−09 | −4.1881091E−08 | 3.2342705E−10 | 4.0375327E−10 |
| A10 | −7.4543885E−11 | 5.3860015E−09 | −7.9926685E−12 | 4.7775790E−11 |
| A11 | 8.1639891E−11 | 2.9945916E−10 | −1.6954644E−12 | −3.8808383E−12 |
| A12 | −2.0836008E−12 | −1.1004476E−10 | 4.7992720E−14 | −1.1979815E−13 |
| A13 | −3.7196382E−13 | 3.3076681E−12 | 5.5806501E−15 | 1.6510857E−14 |
| A14 | 1.7251268E−14 | 9.4545835E−13 | −1.7825711E−16 | 2.2161158E−17 |
| A15 | 9.1653687E−16 | −7.1173003E−14 | −1.0850626E−17 | −3.6453922E−17 |
| A16 | −5.9729744E−17 | −3.0129092E−15 | 3.8151859E−19 | 4.8540446E−19 |
| A17 | −1.0644149E~18 | 4.4725343E−16 | 1.1286119E−20 | 4.0739329E−20 |
| A18 | 9.7810153E−20 | −3.6544451E−18 | −4.2428173E−22 | −8.9682291E−22 |
| A19 | 3.5114197E−22 | −9.7886443E−19 | −4.8200712E−24 | −1.8233051E−23 |
| A20 | −6.0464134E−23 | 3.0063539E−20 | 1.8849956E−25 | 5.0685609E−25 |

| Sn | 27 | 28 |
|---|---|---|
| KA | 1.0000000E+00 | 1.0000000E+00 |
| A3 | 2.2525733E−04 | 1.1302044E−03 |
| A4 | −5.3223601E−05 | −1.3977962E−04 |
| A5 | 2.3673330E−06 | −7.6931590E−06 |
| A6 | 3.2537079E−07 | 1.8538876E−06 |
| A7 | −2.0161644E−08 | 2.0083361E−09 |
| A8 | −1.4757407E−09 | −1.1639746E−08 |
| A9 | 7.2937229E−11 | 1.9153278E−10 |
| A10 | 5.2787388E−12 | 4.0742808E−11 |
| A11 | −1.5289625E−13 | −9.1806091E−13 |
| A12 | −1.3374041E−14 | −8.6356556E−14 |
| A13 | 2.0696929E−16 | 2.0226481E−15 |
| A14 | 2.1873269E−17 | 1.1386966E−16 |
| A15 | −1.8516737E−19 | −2.3953502E−18 |
| A16 | −2.1628138E−20 | −9.1654814E−20 |
| A17 | 9.9676089E−23 | 1.4709578E−21 |
| A18 | 1.1696307E−23 | 4.1328187E−23 |
| A19 | −2.3852095E−26 | −3.6712248E−25 |
| A20 | −2.6484155E−27 | −8.0110037E−27 |

### Example 3

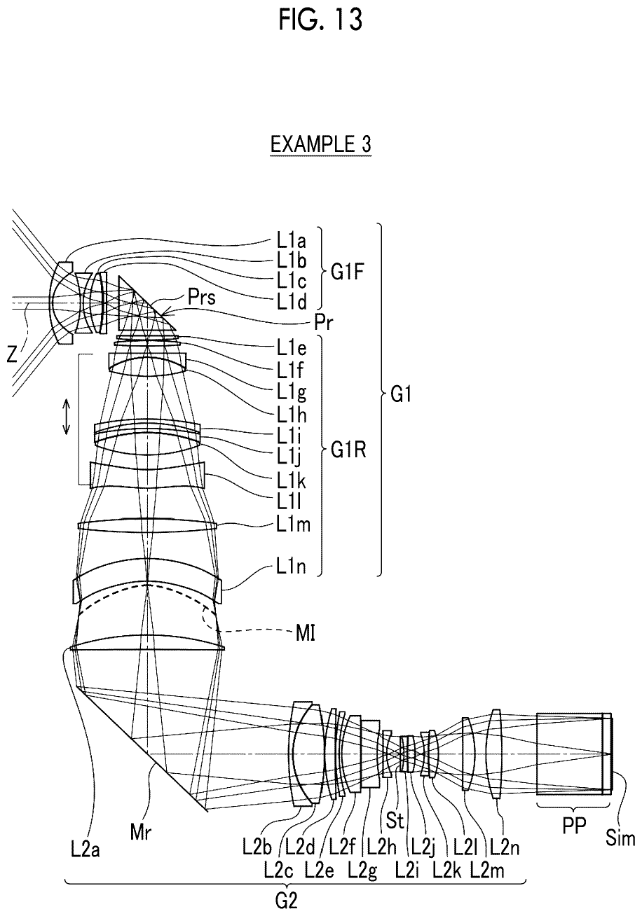

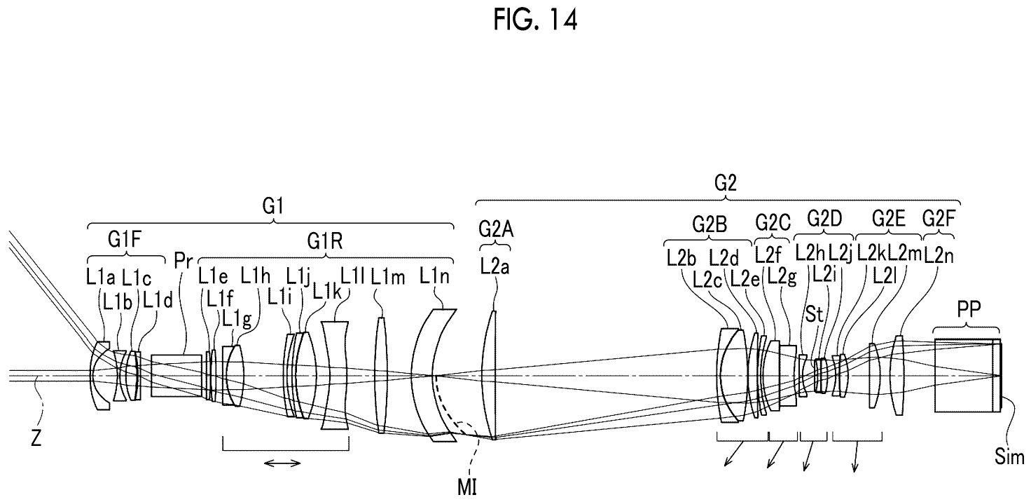

FIG. 13 shows a cross-sectional view of a configuration and luminous flux of a projection optical system of Example 3. FIG. 14 shows a cross-sectional view of an optical path of the projection optical system of Example 3. The projection optical system of Example 3 consists of a first optical system G1 and a second optical system G2, in order from the magnification side to the reduction side along the optical path. An intermediate image MI is formed between the first optical system G1 and the second optical system G2.

The first optical system G1 consists of a front group GIF, a prism Pr, and a rear group G1R, in order from the magnification side to the reduction side along the optical path. The front group GIF consists of lenses L1a to L1d, in order from the magnification side to the reduction side along the optical path. The rear group G1R consists of lenses L1e to L1n, in order from the magnification side to the reduction side along the optical path. A reflecting surface Prs inside the prism Pr functions as an optical path deflection surface which deflects the optical path by 90 degrees. The focusing group consists of lenses L1g to L1l.

The second optical system G2 consists of, in order from the magnification side to the reduction side along the optical path, a second A lens group G2A, a planar mirror Mr, a second B lens group G2B, a second C lens group G2C, and a second D lens group G2D, a second E lens group G2E, and a second F lens group G2F. The second A lens group G2A consists of a lens L2a. The second B lens group G2B consists of lenses L2b to L2e. The second C lens group G2C consists of lenses L2f to L2g. The second D lens group G2D consists of a lens L2h, an aperture stop St, and lenses L2i to L2j. The second E lens group G2E consists of lenses L2k to L2m. The second F lens group G2F consists of lenses L2n. During magnification change, the second A lens group G2A and the second F lens group G2F remain stationary with respect to the display surface Sim, and the second B lens group G2B, the second C lens group G2C, the second D lens group G2D, and the 2E lens group G2E move along the optical axis Z by changing the spacings between the adjacent lens groups. The planar mirror Mr functions as an optical path deflection surface which deflects an optical path by 90 degrees.

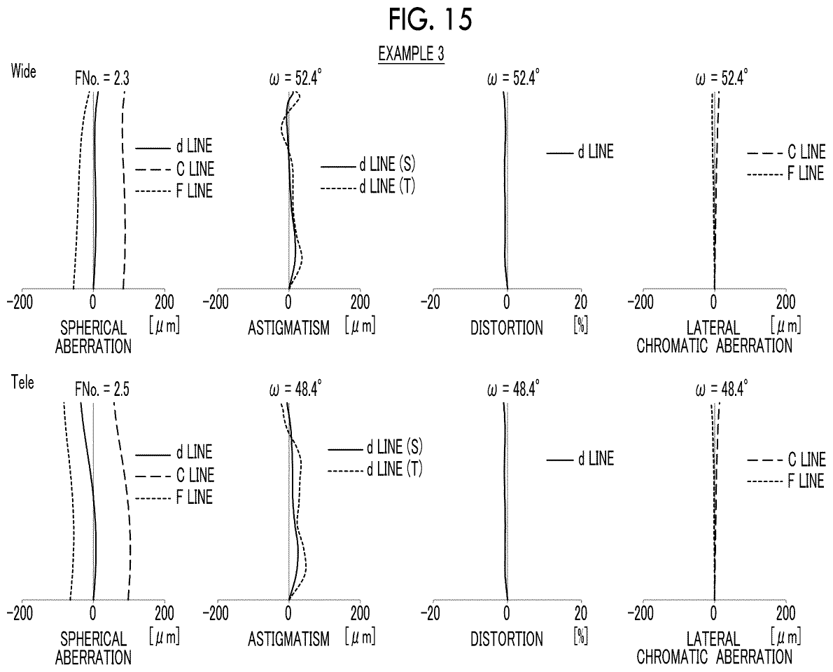

Regarding the projection optical system of Example 3, Tables 7A and 7B show basic lens data, Table 8 shows specifications and variable surface spacings, and Table 9 shows aspherical coefficients thereof. FIG. 15 shows aberration diagrams thereof. The aberration diagrams are in a state where the projection distance is 1.55 meters (m).

TABLE 7A
Example 3

| Sn | R | D | Nd | νd | ER | AH |
|---|---|---|---|---|---|---|
| *1 | 51.8527 | 1.1176 | 1.85135 | 40.10 | 14.000 | 2.329 |
| *2 | 13.0849 | 9.7306 | | | 10.916 | 2.302 |
| 3 | −34.5112 | 1.0003 | 1.44687 | 88.43 | 10.326 | 3.409 |
| 4 | 20.2308 | 2.3960 | | | 9.896 | 3.576 |
| 5 | 26.1333 | 4.3328 | 1.87422 | 39.90 | 10.137 | 4.187 |
| 6 | −64.0876 | 0.4235 | | | 9.950 | 4.399 |
| 7 | −46.6061 | 1.0666 | 1.54236 | 73.24 | 9.895 | 4.415 |
| 8 | −1190974.0101 | 4.2967 | | | 9.560 | 4.494 |
| 9 | ∞ | 10.0000 | 1.71299 | 53.87 | 8.500 | 4.902 |
| Prs | ∞ | 10.0000 | 1.71299 | 53.87 | — | — |
| 10 | ∞ | 2.0000 | | | 8.500 | 6.007 |
| 11 | ∞ | 1.6394 | 1.84850 | 43.79 | 9.603 | 6.197 |
| 12 | −92.7529 | 0.1210 | | | 9.902 | 6.271 |
| 13 | 105.7967 | 2.0322 | 1.90265 | 35.77 | 10.395 | 6.290 |
| 14 | −166.8938 | 2.6214 | | | 10.580 | 6.274 |
| 15 | 2931.5541 | 1.5003 | 1.78880 | 28.42 | 11.294 | 6.134 |
| 16 | 24.0765 | 6.9364 | 1.59410 | 60.47 | 11.929 | 6.071 |
| 17 | 47.8578 | 15.7348 | | | 12.431 | 6.078 |
| 18 | 85.2697 | 1.5008 | 1.77050 | 29.66 | 16.577 | 4.858 |
| 19 | 51.3624 | 1.9794 | | | 16.659 | 4.751 |
| 20 | 84.7300 | 1.5000 | 1.90881 | 36.72 | 16.995 | 4.662 |
| 21 | 49.4874 | 8.2063 | 1.53861 | 73.93 | 17.213 | 4.581 |
| 22 | −49.1041 | 5.3847 | | | 17.568 | 4.263 |
| *23 | −43.5868 | 6.7759 | 1.51623 | 64.05 | 18.146 | 3.661 |
| *24 | −58.0750 | 11.0761 | | | 19.309 | 3.355 |
| 25 | 175.2052 | 5.0001 | 1.91000 | 19.52 | 23.412 | 2.271 |
| 26 | −205.5821 | 9.5640 | | | 23.605 | 1.990 |
| *27 | 45.7200 | 8.3113 | 1.51007 | 56.24 | 24.939 | 0.858 |
| *28 | 40.2400 | 19.7669 | | | 23.591 | 0.162 |

TABLE 7B
Example 3

| Sn | R | D | Nd | νd | ER | AH |
|---|---|---|---|---|---|---|
| 29 | 83.7349 | 5.3385 | 1.88562 | 29.52 | 26.219 | 2.344 |
| 30 | 1966.2303 | 38.4010 | | | 26.142 | 2.626 |
| Mr | ∞ | DD[30] | | | — | — |
| 31 | 96.5801 | 1.5004 | 1.57099 | 50.80 | 19.091 | 10.990 |
| 32 | 27.6390 | 10.8686 | 1.55032 | 75.50 | 18.469 | 11.050 |
| 33 | −97.0970 | 0.1221 | | | 18.300 | 11.249 |
| 34 | 57.0053 | 3.6891 | 1.91000 | 36.66 | 17.191 | 11.202 |
| 35 | 552.0412 | 0.1000 | | | 16.831 | 10.911 |
| 36 | 82.4410 | 1.2443 | 1.48750 | 58.01 | 16.044 | 10.776 |
| 37 | 55.0765 | DD[37] | | | 15.266 | 10.510 |
| 38 | 35.0540 | 6.5639 | 1.90999 | 29.87 | 14.151 | 10.274 |
| 39 | 10102.8358 | 0.1665 | | | 12.518 | 9.119 |
| 40 | 1957.2603 | 5.6571 | 1.85451 | 25.15 | 12.294 | 9.033 |
| 41 | 52.2441 | DD[41] | | | 9.418 | 7.557 |
| 42 | −1103.2155 | 1.2901 | 1.62302 | 38.34 | 8.582 | 7.076 |
| 43 | 17.4245 | 4.8065 | | | 7.428 | 6.583 |
| 44(St) | ∞ | 1.2200 | | | 6.380 | 6.380 |
| 45 | −28.2785 | 1.2018 | 1.73325 | 30.35 | 6.459 | 6.358 |
| 46 | 417.7761 | 0.1205 | | | 6.851 | 6.499 |
| 47 | 143.8563 | 2.6270 | 1.81031 | 48.44 | 6.937 | 6.529 |
| 48 | −28.0369 | DD[48] | | | 7.197 | 6.621 |
| 49 | −22.1203 | 1.3969 | 1.89286 | 20.36 | 7.589 | 6.240 |
| 50 | 88.6952 | 0.1789 | | | 8.270 | 6.446 |
| 51 | 112.9907 | 3.3835 | 1.43875 | 94.66 | 8.327 | 6.476 |
| 52 | −27.0956 | 8.5271 | | | 8.863 | 6.795 |
| 53 | −1470.0400 | 4.2726 | 1.90389 | 30.75 | 12.737 | 7.585 |
| 54 | −38.2878 | DD[54] | | | 13.270 | 7.751 |
| 55 | 53.4816 | 5.5568 | 1.69560 | 59.05 | 16.209 | 7.227 |
| 56 | −205.9578 | 12.3352 | | | 16.149 | 6.655 |
| 57 | ∞ | 23.0000 | 1.51633 | 64.14 | 14.877 | 3.883 |
| 58 | ∞ | 3.0000 | 1.48749 | 70.44 | 13.395 | 0.555 |
| 59 | ∞ | 0.5151 | | | 13.198 | 0.112 |

TABLE 8
Example 3

| | Wide | Tele |
|---|---|---|
| Zr | 1.00 | 1.15 |
| \|f\| | 10.26 | 11.80 |
| Bf | 29.97 | 29.95 |
| FNo. | 2.3 | 2.5 |
| 2ω[°] | 104.8 | 96.8 |
| DD[30] | 49.54 | 40.58 |
| DD[37] | 0.94 | 1.41 |
| DD[41] | 2.07 | 2.00 |
| DD[48] | 3.21 | 4.90 |
| DD[54] | 3.87 | 10.73 |

TABLE 9
Example 3

| Sn | 1 | 2 | 23 | 24 |
|---|---|---|---|---|
| KA | 1.0000000E+00 | 1.0000000E+00 | 1.0000000E+00 | 1.0000000E+00 |
| A3 | −4.0974740E−05 | 1.1561689E−04 | 5.5398457E−05 | 3.2081785E−05 |
| A4 | 9.7134805E−05 | 2.7997076E−05 | −1.1455787E−05 | 9.4623093E−06 |
| A5 | −4.9095987E−06 | 1.5026191E−05 | 2.3474894E−06 | −1.6433918E−06 |
| A6 | 1.1791956E−07 | −4.5926785E−06 | 5.5089662E−07 | 7.7764943E−07 |
| A7 | 7.9405414E−08 | 1.4868092E−07 | −6.3320933E−08 | −1.6378125E−08 |
| A8 | −3.7263488E−08 | 2.0534231E−07 | −4.7435005E−09 | −9.2280303E−09 |
| A9 | 2.0185181E−09 | −3.1730803E−08 | 7.3348168E−10 | 4.7764533E−10 |
| A10 | 5.5825545E−10 | −3.4267698E−09 | 1.6402293E−11 | 5.0690497E−11 |
| A11 | −5.5078616E−11 | 9.6300750E−10 | −4.5582968E−12 | −3.9136378E−12 |
| A12 | −3.2116524E−12 | 8.4926775E−12 | 1.3345840E−14 | −1.2557178E−13 |
| A13 | 5.1272752E−13 | −1.3277846E−11 | 1.6052678E−14 | 1.5716519E−14 |
| A14 | 4.1304009E−15 | 3.8462387E−13 | −2.7910859E−16 | 4.2497706E−17 |
| A15 | −2.3517279E−15 | 9.3426675E−14 | −3.2041514E−17 | −3.3697803E−17 |
| A16 | 3.3802047E−17 | −4.6161436E−15 | 8.5570179E−19 | 4.2762120E−19 |
| A17 | 5.3796403E−18 | −3.2123019E−16 | 3.3758519E−20 | 3.6976604E−20 |
| A18 | −1.4545891E−19 | 2.0293668E−17 | −1.1237648E−21 | −8.1733732E−22 |
| A19 | −4.9128890E−21 | 4.1698744E−19 | −1.4577835E−23 | −1.6328460E−23 |
| A20 | 1.7272758E−22 | −3.1243194E−20 | 5.5797714E−25 | 4.6598177E−25 |

| Sn | 27 | 28 |
|---|---|---|
| KA | 1.0000000E+00 | 1.0000000E+00 |
| A3 | 3.7162047E−04 | 5.5067947E−04 |
| A4 | −7.6907998E−05 | −3.9753037E−05 |
| A5 | 1.4059114E−06 | −3.7292776E−06 |
| A6 | 6.3495144E−07 | 3.2581882E−07 |
| A7 | −2.7334338E−08 | 8.8384466E−09 |
| A8 | −2.6983425E−09 | −1.0595168E−09 |
| A9 | 1.4261145E−10 | −7.9425591E−12 |
| A10 | 6.5504918E−12 | 7.3837701E−13 |
| A11 | −3.8432694E−13 | 2.5375054E−14 |
| A12 | −9.2583166E−15 | 4.0860946E−15 |
| A13 | 6.0050919E−16 | −1.1465338E−16 |
| A14 | 7.2724826E−18 | −1.2011968E−17 |
| A15 | −5.4900926E−19 | 2.0611682E−19 |
| A16 | −2.6201004E−21 | 1.4218192E−20 |
| A17 | 2.7282979E−22 | −1.6105774E−22 |
| A18 | 3.5256417E−26 | −8.0652303E−24 |
| A19 | −5.6980627E−26 | 4.6529023E−26 |
| A20 | 1.5638821E−28 | 1.8053546E−27 |

### Example 4

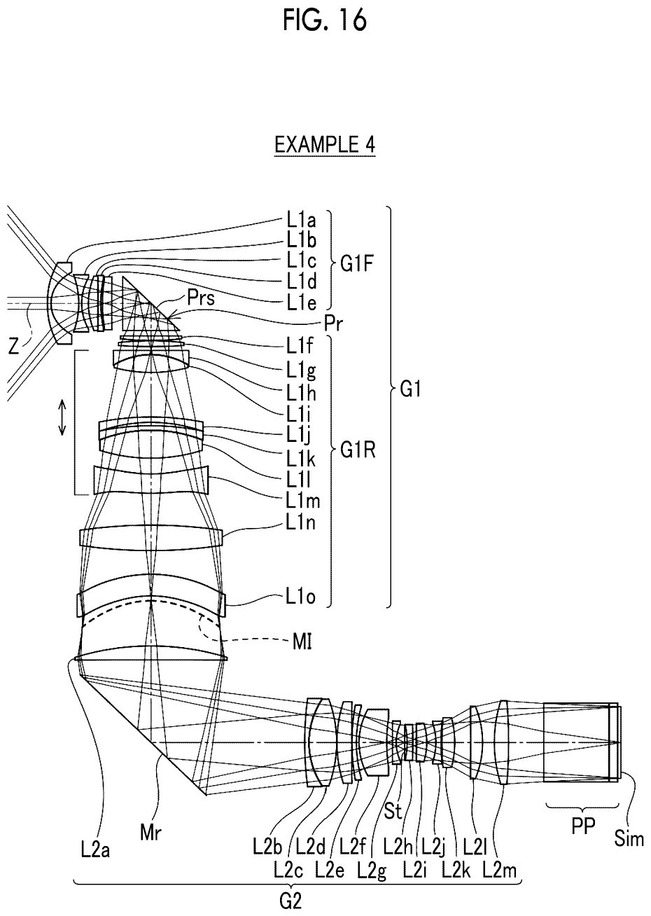

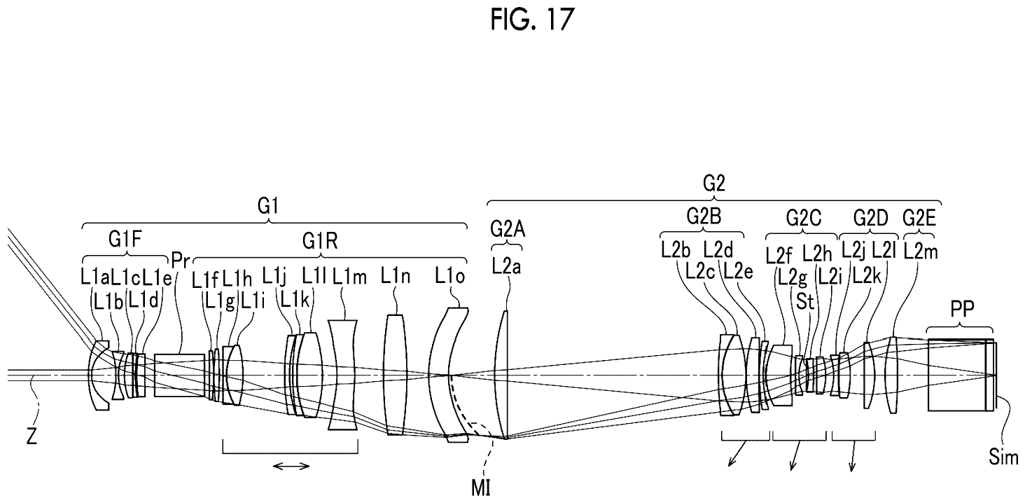

FIG. 16 shows a cross-sectional view of a configuration and luminous flux of a projection optical system of Example 4. FIG. 17 shows a cross-sectional view of an optical path of the projection optical system of Example 4. The projection optical system of Example 4 consists of a first optical system G1 and a second optical system G2, in order from the magnification side to the reduction side along the optical path. An intermediate image MI is formed between the first optical system G1 and the second optical system G2.

The first optical system G1 consists of a front group GIF, a prism Pr, and a rear group G1R, in order from the magnification side to the reduction side along the optical path. The front group GIF consists of lenses L1a to L1e, in order from the magnification side to the reduction side along the optical path. The rear group G1R consists of lenses L1f to L10, in order from the magnification side to the reduction side along the optical path. A reflecting surface Prs inside the prism Pr functions as an optical path deflection surface which deflects the optical path by 90 degrees. The focusing group consists of lenses L1h to L1m.

The second optical system G2 consists of, in order from the magnification side to the reduction side along the optical path, a second A lens group G2A, a planar mirror Mr, a second B lens group G2B, a second C lens group G2C, a second D lens group G2D, and a second E lens group G2E. The second A lens group G2A consists of a lens L2a. The second B lens group G2B consists of lenses L2b to L2e. The second C lens group G2C consists of lenses L2f to L2g, an aperture stop St, and lenses L2h to L2i. The second D lens group G2D consists of lenses L2j to L2l. The second E lens group G2E consists of the lens L2m. During magnification change, the second A lens group G2A and the second E lens group G2E remain stationary with respect to the display surface Sim, and the second B lens group G2B, the second C lens group G2C, and the second D lens group G2D move along the optical axis Z by changing the spacings between the adjacent lens groups. The planar mirror Mr functions as an optical path deflection surface which deflects an optical path by 90 degrees.

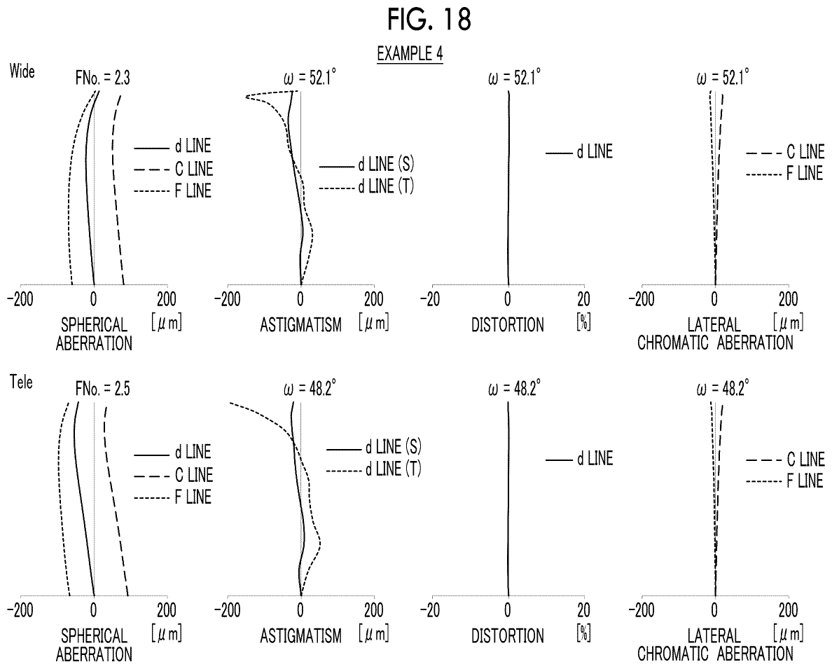

Regarding the projection optical system of Example 4, Tables 10A and 10B show basic lens data, Table 11 shows specifications and variable surface spacings, and Table 12 shows aspherical coefficients thereof. FIG. 18 shows aberration diagrams thereof. The aberration diagrams are in a state where the projection distance is 1.55 meters (m).

TABLE 10A
Example 4

| Sn | R | D | Nd | νd | ER | AH |
|---|---|---|---|---|---|---|
| *1 | 47.8152 | 1.2606 | 1.85135 | 40.10 | 14.000 | 2.337 |
| *2 | 12.8855 | 9.7591 | | | 10.676 | 2.303 |
| 3 | −30.9716 | 1.0023 | 1.43700 | 95.10 | 9.692 | 3.401 |
| 4 | 19.6661 | 2.3807 | | | 8.903 | 3.576 |
| 5 | 26.8280 | 3.2573 | 1.87034 | 40.88 | 9.072 | 4.190 |
| 6 | 9304.9977 | 0.1202 | | | 8.895 | 4.358 |
| 7 | −1387.3530 | 1.0010 | 1.55832 | 45.03 | 8.879 | 4.370 |
| 8 | 47.6368 | 0.5786 | | | 8.699 | 4.455 |
| 9 | 63.7999 | 3.2519 | 1.81850 | 42.58 | 8.683 | 4.543 |
| 10 | 1180.3462 | 3.8226 | | | 8.452 | 4.718 |
| 11 | ∞ | 10.0000 | 1.71299 | 53.87 | 7.876 | 5.127 |
| Prs | ∞ | 10.0000 | 1.71299 | 53.87 | — | — |
| 12 | ∞ | 2.0000 | | | 8.500 | 6.370 |
| 13 | ∞ | 1.6819 | 1.84850 | 43.79 | 9.576 | 6.584 |
| 14 | −90.2206 | 0.121 | | | 9.877 | 6.667 |
| 15 | 104.2097 | 2.1263 | 1.90265 | 35.77 | 10.359 | 6.692 |
| 16 | −160.3950 | 1.4528 | | | 10.548 | 6.678 |
| 17 | −13989.4635 | 1.5001 | 1.77971 | 31.90 | 10.957 | 6.594 |
| 18 | 24.4484 | 6.5699 | 1.59282 | 68.62 | 11.511 | 6.523 |
| 19 | −47.5919 | 16.3868 | | | 11.974 | 6.523 |
| 20 | 89.9903 | 1.9707 | 1.83685 | 28.11 | 15.627 | 5.111 |
| 21 | 51.6602 | 1.2579 | | | 15.684 | 4.964 |
| 22 | 87.2175 | 1.6512 | 1.76600 | 28.73 | 15.770 | 4.906 |
| 23 | 47.5685 | 10.2776 | 1.52841 | 76.45 | 16.061 | 4.813 |
| 24 | −57.1845 | 5.8142 | | | 16.914 | 4.371 |
| *25 | −43.4160 | 7.0999 | 1.51623 | 64.05 | 17.539 | 3.729 |
| *26 | −63.3853 | 11.5240 | | | 18.856 | 3.415 |
| 27 | 166.8842 | 9.3602 | 1.90975 | 19.76 | 23.420 | 2.333 |
| 28 | −162.5925 | 8.7117 | | | 24.021 | 1.819 |
| *29 | 46.1391 | 7.9516 | 1.51007 | 56.24 | 25.036 | 0.802 |
| *30 | 40.5409 | 18.4457 | | | 24.029 | 0.148 |

TABLE 10B
Example 4

| Sn | R | D | Nd | νd | ER | AH |
|---|---|---|---|---|---|---|
| 31 | 86.812 | 5.1250 | 1.90574 | 37.09 | — | — |
| 32 | 4507.9267 | 30.4387 | | | 25.740 | 2.148 |
| Mr | ∞ | DD[32] | | | 25.649 | 2.417 |
| 33 | 129.3858 | 1.5101 | 1.51860 | 69.89 | 16.202 | 10.381 |
| 34 | 29.7752 | 9.4995 | 1.43700 | 95.10 | 15.978 | 10.485 |
| 35 | −47.7485 | 0.1239 | | | 15.957 | 10.859 |
| 36 | 51.3793 | 5.1579 | 1.80809 | 22.74 | 15.044 | 10.816 |
| 37 | 1177.1119 | 0.1000 | | | 14.341 | 10.388 |
| 38 | 80.4275 | 1.5752 | 1.60637 | 37.39 | 13.807 | 10.255 |
| 39 | 51.6802 | DD[39] | | | 13.112 | 9.945 |
| 40 | 25.9073 | 9.7110 | 1.73184 | 54.86 | 12.208 | 9.677 |
| 41 | 63.4727 | 2.0324 | | | 8.970 | 7.593 |
| 42 | 11140.1865 | 1.3203 | 1.67286 | 32.51 | 7.941 | 7.035 |
| 43 | 17.1015 | 2.9734 | | | 6.894 | 6.506 |
| 44(St) | ∞ | 0.8500 | | | 6.390 | 6.390 |
| 45 | −30.2561 | 1.9991 | 1.84354 | 23.85 | 6.401 | 6.380 |
| 46 | −258.0141 | 1.2922 | | | 6.753 | 6.557 |
| 47 | −442.1649 | 3.6124 | 1.80749 | 48.64 | 7.115 | 6.696 |
| 48 | −25.0195 | DD[48] | | | 7.506 | 6.870 |
| 49 | −23.8188 | 1.8204 | 1.89286 | 20.36 | 7.596 | 6.407 |
| 50 | 88.6952 | 0.2842 | | | 8.190 | 6.605 |
| 51 | 112.9907 | 4.5201 | 1.43875 | 94.66 | 8.285 | 6.652 |
| 52 | −37.2731 | 5.5934 | | | 9.123 | 7.083 |
| 53 | −1287.3367 | 4.1900 | 1.80929 | 28.54 | 12.719 | 7.619 |
| 54 | −36.2832 | DD[54] | | | 13.243 | 7.787 |
| 55 | 52.9281 | 5.0184 | 1.73144 | 54.89 | 15.357 | 7.295 |
| 56 | −189.8031 | 12.3352 | | | 15.344 | 6.809 |
| 57 | ∞ | 23.0000 | 1.51633 | 64.14 | 14.434 | 4.035 |
| 58 | ∞ | 3.0000 | 1.48749 | 70.44 | 13.371 | 0.707 |
| 59 | ∞ | 1.1925 | | | 13.229 | 0.264 |

TABLE 11
Example 4

| | Wide | Tele |
|---|---|---|
| Zr | 1 | 1.15 |
| \|f\| | 10.26 | 11.79 |
| Bf | 30.65 | 30.63 |
| FNo. | 2.3 | 2.5 |
| 2ω[°] | 104.2 | 96.4 |
| DD[32] | 54 | 45.77 |
| DD[39] | 0.94 | 1.26 |
| DD[48] | 3.21 | 5.37 |
| DD[54] | 4.14 | 9.88 |

TABLE 12
Example 4

| Sn | 1 | 2 | 25 | 26 |
|---|---|---|---|---|
| KA | 1.0000000E+00 | 1.0000000E+00 | 1.0000000E+00 | 1.0000000E+00 |
| A3 | −2.5362436E−04 | −2.5435783E−04 | 1.2863124E−05 | −3.4184462E−05 |
| A4 | 2.5153380E−04 | 2.7471118E−04 | 5.0933375E−06 | 3.5180530E−05 |
| A5 | −1.0191539E−05 | −7.4110073E−06 | 2.4099278E−06 | −2.8148316E−06 |
| A6 | −5.7374933E−06 | −1.0159658E−05 | 3.8439563E−08 | 4.9190492E−07 |
| A7 | 5.8036604E−07 | 1.3257858E−06 | −3.4036627E−08 | 1.7188671E−09 |
| A8 | 5.8140470E−08 | 7.4989630E−08 | 4.4124905E−10 | −7.6833004E−09 |
| A9 | −9.8275091E−09 | −3.1289053E−08 | 2.7456531E−10 | 3.8851191E−10 |
| A10 | −1.8113197E−10 | 2.8680736E−09 | −6.4161388E−12 | 4.5652846E−11 |
| A11 | 8.2538943E−11 | 1.2312694E−10 | −1.4726017E−12 | −3.8182135E−12 |
| A12 | −1.2466625E−12 | −6.8894374E−11 | 4.3148273E−14 | −1.1181477E−13 |
| A13 | −3.8245430E−13 | 5.0783244E−12 | 4.9654112E−15 | 1.6369439E−14 |
| A14 | 1.3133644E−14 | 5.2857242E−13 | −1.6877601E−16 | 4.0723245E−18 |
| A15 | 9.7058577E−16 | −8.1678575E−14 | −9.8479903E−18 | −3.6289639E−17 |
| A16 | −4.7380601E−17 | −4.6214315E−16 | 3.6985398E−19 | 5.0945514E−19 |
| A17 | −1.1988099E−18 | 4.8088493E−16 | 1.0400660E−20 | 4.0664022E−20 |
| A18 | 7.7159126E−20 | −1.2284789E−17 | −4.1592484E−22 | −9.1392514E−22 |
| A19 | 4.8245222E−22 | −1.0231752E−18 | −4.4940690E−24 | −1.8235044E−23 |
| A20 | −4.5688146E−23 | 4.2459394E−20 | 1.8580499E−25 | 5.1180323E−25 |

| Sn | 29 | 30 |
|---|---|---|
| KA | 1.0000000E+00 | 1.0000000E+00 |
| A3 | 2.7151012E−04 | 1.0576983E−03 |
| A4 | −5.6211750E−05 | −1.3775220E−04 |
| A5 | 2.0484855E−06 | −6.2255200E−06 |
| A6 | 3.5486906E−07 | 1.8481872E−06 |
| A7 | −1.8864375E−08 | −1.0054130E−08 |
| A8 | −1.6388025E−09 | −1.1694898E−08 |
| A9 | 6.9182121E−11 | 2.4454952E−10 |
| A10 | 5.8343355E−12 | 4.1175930E−11 |
| A11 | −1.4460983E−13 | −1.0547207E−12 |
| A12 | −1.4560704E−14 | −8.7666119E−14 |
| A13 | 1.9406829E−16 | 2.2346569E−15 |
| A14 | 2.3455593E−17 | 1.1597507E−16 |
| A15 | −1.7253786E−19 | −2.5896168E−18 |
| A16 | −2.2904236E−20 | −9.3553384E−20 |
| A17 | 9.2861154E−23 | 1.5676949E−21 |
| A18 | 1.2265023E−23 | 4.2237268E−23 |
| A19 | −2.2318783E−26 | −3.8729309E−25 |
| A20 | −2.7558203E−27 | −8.1915463E−27 |

Table 13 shows corresponding values of Conditional Expressions (1) to (10) and values of Imax and DifP for the projection optical systems of Examples 1 to 4. Preferable ranges of the conditional expressions may be set by using the corresponding values of the examples shown in Table 13 as the upper limits or the lower limits of the conditional expressions.

TABLE 13

| Expression | | | | | |
|---|---|---|---|---|---|
| Number | | Example 1 | Example 2 | Example 3 | Example 4 |
| (1) | Imax/Ddef | 0.362 | 0.377 | 0.383 | 0.361 |
| (2) | νnave-νpave | 20.81 | 24.04 | 27.36 | 18.35 |
| (3) | Npave-Nnave | 0.247 | 0.262 | 0.261 | 0.229 |
| (4) | Imax/Dfr | 0.712 | 0.737 | 0.732 | 0.751 |
| (5) | Imax/(Dpr/Npr) | 1.126 | 1.126 | 1.126 | 1.126 |
| (6) | ERf/ERmax | 0.539 | 0.541 | 0.534 | 0.544 |
| (7) | AH1/AH2 | 0.619 | 0.531 | 0.559 | 0.616 |
| (8) | DifP/Imax | −0.708 | −0.686 | −0.679 | −0.763 |
| (9) | \|DifP/Dfr\| | 0.504 | 0.505 | 0.497 | 0.573 |
| (10) | \|DifP/(Dpr/Npr)\| | 0.197 | 0.772 | 0.165 | 0.859 |

| | | | | |
|---|---|---|---|---|
| Imax | 13.15 | 13.15 | 13.15 | 13.15 |
| DifP | −9.30724 | −9.01542 | −8.92938 | −10.02712 |

The projection optical systems of Examples 1 to 4 each have a wide angle of view which is a total angle of view of 100 degrees or more at the wide-angle end. The projection optical systems of Examples 1 to 4 have an F number of 2.3 or less at the wide-angle end, which is a small F number. Further, while the projection optical systems of Examples 1 to 4 are configured to have a small size, the projection optical system implements high optical performance by satisfactorily correcting various aberrations.

In general, it is often necessary for a projection optical system to provide a projection image with a wide angle of view, and recently, it is also often necessary for the projection optical system to be able to project a large screen from the vicinity of a screen. For these reasons, the lens closest to the magnification side in the projection optical system tends to be increased in size. On the other hand, according to the projection optical system of the present disclosure, it is possible to achieve reduction in size of the lens closest to the magnification side. Further, according to the projection optical system of the present disclosure, the optical path deflection surface is included. Therefore, it is possible to provide a high degree of freedom in installation while being compactly configured.

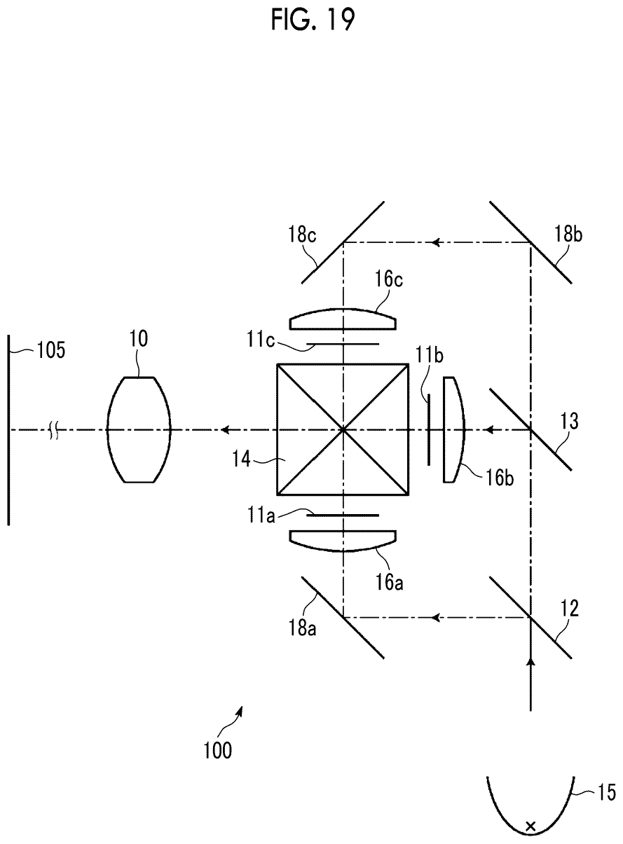

Next, a projection type display device according to an embodiment of the present disclosure will be described. FIG. 19 is a schematic configuration diagram of a projection type display device according to an embodiment of the present disclosure. The projection type display device 100 shown in FIG. 19 has a projection optical system 10 according to an embodiment of the present disclosure, a light source 15, and transmissive display elements 11a to 11c as light valves corresponding to each color light and outputting an optical image. Further, the projection type display device 100 has dichroic mirrors 12 and 13 for color separation, cross dichroic prisms 14 for color synthesis, condenser lenses 16a to 16c, and total reflection mirrors 18a to 18c for deflecting the optical path. It should be noted that, FIG. 19 schematically shows the projection optical system 10. Further, an integrator is disposed between the light source 15 and the dichroic mirror 12, but is not shown in FIG. 19.

White light originating from the light source 15 is separated into rays with three colors (green light, blue light, and red light) through the dichroic mirrors 12 and 13. Thereafter, the ray respectively passing through the condenser lenses 16a to 16c, are incident into and modulated through the transmissive display elements 11a to 11c respectively corresponding to the ray with the respective colors, are subjected to color synthesis through the cross dichroic prism 14, and are subsequently incident into the projection optical system 10. The projection optical system 10 projects an optical image, which is based on the modulated light modulated through the transmissive display elements 11a to 11c, onto a screen 105.

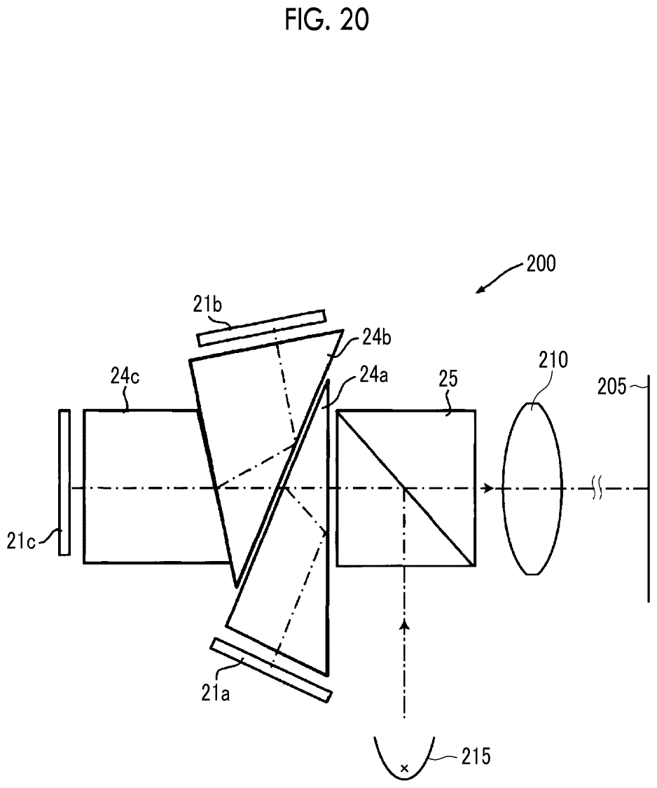

FIG. 20 is a schematic configuration diagram of a projection type display device according to another embodiment of the present disclosure. The projection type display device 200 shown in FIG. 20 has a projection optical system 210 according to an embodiment of the present disclosure, a light source 215, and digital micromirror device (DMD: registered trademark) elements 21a to 21c as light valves each of which outputs an optical image corresponding to each color light. Further, the projection type display device 200 has total internal reflection (TIR) prisms 24a to 24c for color separation and color synthesis, and a polarized light separating prism 25 that separates illumination light and projection light. It should be noted that FIG. 20 schematically shows the projection optical system 210. Further, an integrator is disposed between the light source 215 and the polarized separating prism 25, but is not shown in FIG. 20.

White light originating from the light source 215 is reflected on a reflecting surface inside the polarized light separating prism 25, and is separated into ray with three colors (green light, blue light, and red light) through the TIR prisms 24a to 24c. The separated ray with the respective colors are respectively incident into and modulated through the corresponding DMD elements 21a to 21c, travel through the TIR prisms 24a to 24c again in a reverse direction, are subjected to color synthesis, are subsequently transmitted through the polarized light separating prism 25, and are incident into the projection optical system 210. The projection optical system 210 projects an optical image, which is based on the modulated light modulated through the DMD elements 21a to 21c, onto a screen 205.

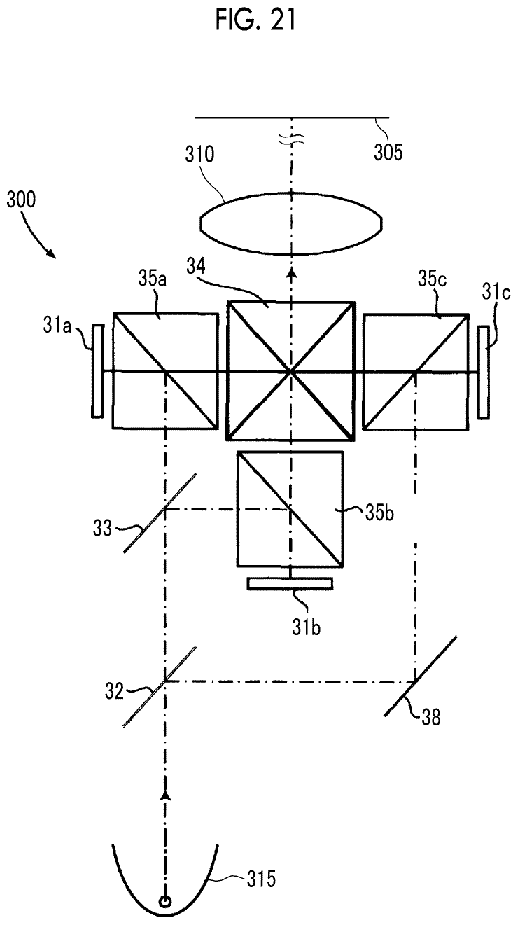

FIG. 21 is a schematic configuration diagram of a projection type display device according to still another embodiment of the present disclosure. The projection type display device 300 shown in FIG. 21 has a projection optical system 310 according to an embodiment of the present disclosure, a light source 315, and reflective display elements 31a to 31c as light valves corresponding to each color light and outputting an optical image. Further, the projection type display device 300 has dichroic mirrors 32 and 33 for color separation, a cross dichroic prism 34 for color synthesis, a total reflection mirror 38 for optical path deflection, and polarized light separating prisms 35a to 35c. It should be noted that, FIG. 21 schematically shows the projection optical system 310. Further, an integrator is disposed between the light source 315 and the dichroic mirror 32, but is not shown in FIG. 21.

White light originating from the light source 315 is separated into ray with three colors (green light, blue light, and red light) through the dichroic mirrors 32 and 33. The separated ray with the respective colors respectively pass through the polarized light separating prisms 35a to 35c, are incident into and modulated through the reflective display elements 31a to 31c respectively corresponding to the ray with the respective colors, are subjected to color synthesis through the cross dichroic prism 34, and are subsequently incident into the projection optical system 310. The projection optical system 310 projects an optical image, which is based on the modulated light modulated through the reflective display elements 31a to 31c, onto a screen 305.

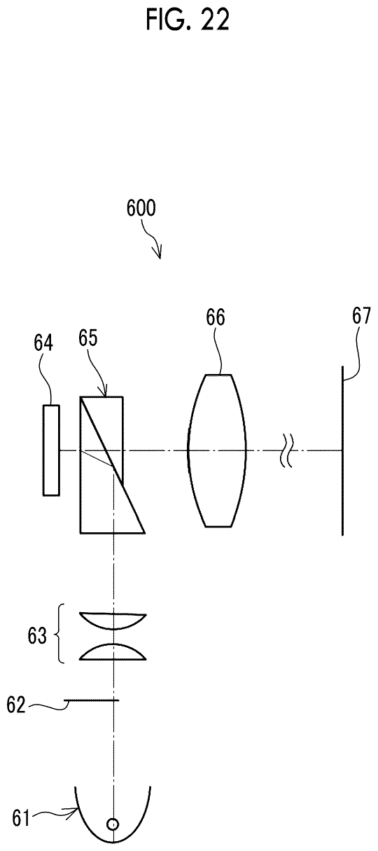

FIG. 22 is a schematic configuration diagram of a projection type display device according to still another embodiment of the present disclosure. The projection type display device 600 shown in FIG. 22 has a projection optical system 66 according to an embodiment of the present disclosure, a light source 61, and a DMD element 64 as a light valve that corresponds to each color light and that outputs an optical image. Further, the projection type display device 600 has a color wheel 62, a light guide optical system 63, and a TIR prism 65. It should be noted that, FIG. 22 schematically shows the projection optical system 66.

Filters having three colors of green, blue, and red are provided on a circumference of the color wheel 62. In a case where the color wheel 62 is rotated, the filters having the respective colors are sequentially inserted on the optical path. White light originating from the light source 61 is incident on the rotating color wheel 62 and is time-divided into luminous flux having three colors (green light, blue light, and red light). The luminous flux having the respective colors after the time-division passes through the light guide optical system 63 and the TIR prism 65, are incident into the DMD elements 64 to be modulated, and are incident into the projection optical system 66 through the TIR prism 65 again. The projection optical system 66 projects an optical image, which is based on the modulated light modulated through the DMD element 64, onto a screen 67.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, the Abbe number, and the aspherical coefficient of each lens are not limited to the values shown in the examples, and different values may be used therefor.

Further, the projection type display device according to the technique of the present disclosure is not limited to the above-mentioned configuration, and may be modified into various forms such as the optical member used for ray separation or ray synthesis and the light valve. The light valve is not limited to a form in which light from a light source is spatially modulated through an image display element and is output as an optical image based on image data, but may be a form in which light itself output from the self-light-emitting image display element is output as an optical image based on the image data. Examples of the self-light-emitting image display element include an image display element in which light emitting elements such as light emitting diodes (LED) or organic light emitting diodes (OLED) are two-dimensionally arranged.

Regarding the above-mentioned embodiments and examples, the following Supplementary Notes will be further disclosed.

### Supplementary Note 1

A projection optical system that projects an image on a reduction side to a magnification side,
in which the projection optical system does not include a reflecting surface having a power,
the projection optical system consists of, in order from the magnification side to the reduction side along an optical path, a first optical system and a second optical system,
an intermediate image is formed between the first optical system and the second optical system,
the first optical system includes an optical path deflection surface which deflects an optical path,
assuming that
   a radius of a maximum effective image circle on the reduction side is Imax,
   a distance on an optical axis from a lens surface closest to the magnification side in the first optical system to the optical path deflection surface is Ddef, and
   Ddef is a value at a wide-angle end in a case where the projection optical system is a variable magnification optical system,
   Conditional Expression (1) is satisfied, which is represented by

$$0.2 < Imax / Ddef < 0.7 . \qquad ( 1 )$$

### Supplementary Note 2

The projection optical system according to Supplementary Note 1, in which the first optical system consists of, in order from the magnification side to the reduction side along the optical path, a front group that has a negative power, an optical path deflection member that includes the optical path deflection surface, and a rear group that has a positive power.

### Supplementary Note 3

The projection optical system according to Supplementary Note 2, in which the front group includes one or more positive lenses.

### Supplementary Note 4

The projection optical system according to Supplementary Note 2 or 3, in which an outermost periphery of an optical effective surface closest to the magnification side in the first optical system is positioned closer to the reduction side in an optical axis direction than an intersection between the optical effective surface and the optical axis.

### Supplementary Note 5

The projection optical system according to any one of Supplementary Notes 2 to 4, in which assuming that
an average value of Abbe numbers of all negative lenses included in the front group based on a d line is vnave, and
an average value of Abbe numbers of all positive lenses included in the front group based on the d line is vpave,
Conditional Expression (2) is satisfied, which is represented by

$$10 < ν nave - ν pave < 40. \qquad ( 2 )$$

### Supplementary Note 6

The projection optical system according to any one of Supplementary Notes 2 to 5, in which assuming that
an average value of refractive indexes of all negative lenses included in the front group at a d line is Nnave, and
an average value of refractive indexes of all positive lenses included in the front group at the d line is Npave,
Conditional Expression (3) is satisfied, which is represented by

$$0.15 < Npave - Nnave < 0.45 . \qquad ( 3 )$$

### Supplementary Note 7

The projection optical system according to any one of Supplementary Notes 2 to 6, wherein at least a part of the rear group moves during focusing.

### Supplementary Note 8

The projection optical system according to any one of Supplementary Notes 1 to 7, in which the second optical system includes two or more movable groups that move along the optical axis during magnification change.

### Supplementary Note 9

The projection optical system according to Supplementary Note 8, in which a movable group closest to the magnification side among the movable groups of the second optical system has a positive power.

### Supplementary Note 10

The projection optical system according to any one of Supplementary Notes 2 to 7, in which assuming that
an air conversion distance on the optical axis from a surface closest to the reduction side in the front group to a surface closest to the magnification side in the rear group is Dfr, and
Dfr is a value at the wide-angle end in a case where the projection optical system is a variable magnification optical system,
Conditional Expression (4) is satisfied, which is represented by

$$0.5 < Imax / Dfr < 0.9 . \qquad ( 4 )$$

### Supplementary Note 11

The projection optical system according to any one of Supplementary Notes 1 to 10, in which the optical path deflection surface is a surface of a prism.

### Supplementary Note 12

The projection optical system according to Supplementary Note 11, in which assuming that
a thickness of the prism along the optical axis is Dpr, and
a refractive index of the prism at the d line is Npr,
Conditional Expression (5) is satisfied, which is represented by

$$0.9 < Imax / ( Dpr / Npr ) < 1.3 . \qquad ( 5 )$$

### Supplementary Note 13

The projection optical system according to any one of Supplementary Notes 1 to 12, in which assuming that
a maximum effective radius of the lens surface closest to the magnification side in the first optical system is ERf, and
a maximum value of maximum effective radii of all lens surfaces of the projection optical system is ERmax,
Conditional Expression (6) is satisfied, which is represented by

$$0 < ERf / ERmax < 0.7 . \qquad ( 6 )$$

### Supplementary Note 14

The projection optical system according to any one of Supplementary Notes 1 to 13, in which assuming that
a maximum value of a height of an on-axis marginal ray from the optical axis on all lens surfaces of the first optical system is AH1, and
a maximum value of a height of the on-axis marginal ray from the optical axis on all lens surfaces of the second optical system is AH2,
Conditional Expression (7) is satisfied, which is represented by

$$0 < AH 1 / AH 2 < 0.7 . \qquad ( 7 )$$

### Supplementary Note 15

The projection optical system according to any one of Supplementary Notes 1 to 14,
in which the projection optical system includes an aperture stop at a position closer to the reduction side than the intermediate image,
a real image of the aperture stop is present inside the first optical system, and
assuming that
   a position of the real image in an optical axis direction is set as a first position, and
   a position farthest from the first position is set as a second position, among positions where a ray, which is emitted from an optional point in a maximum effective image circle on the reduction side and passes through a center of the aperture stop toward the magnification side, intersects the optical axis at a position closer to the magnification side than the intermediate image,
   an intersection between the optical path deflection surface and the optical axis is positioned within a range from the first position to the second position in the optical axis direction.

### Supplementary Note 16

The projection optical system according to Supplementary Note 15, in which assuming that
a natural number of 1 to 10 is k,
a point, of which a height from the optical axis on the maximum effective image circle on the reduction side is a height of k tenths of a radius of the maximum effective image circle, is a point PHk,
a position, at which a ray that is emitted from the point PHk and that passes through the center of the aperture stop toward the magnification side intersects the optical axis at the position closer to the magnification side than the intermediate image, is a position Pk,
a position, at which an air conversion distance on the optical axis from the first position is longest, among the positions Pk is a third position,
an air conversion distance from the first position to the third position is DifP,
a sign of DifP is positive at a distance on the reduction side and is negative at a distance on the magnification side, in a case where the first position is set as a reference, and
DifP is a value at the wide-angle end in a case where the projection optical system is a variable magnification optical system,
Conditional Expression (8) is satisfied, which is represented by

$$- 3 < DifP / Imax < - 0.2 . \qquad ( 8 )$$

### Supplementary Note 17

The projection optical system according to Supplementary Note 16,
in which the first optical system consists of, in order from the magnification side to the reduction side along the optical path, a front group, an optical path deflection member that includes the optical path deflection surface, and a rear group, and
assuming that
   an air conversion distance on the optical axis from a surface closest to the reduction side in the front group to a surface closest to the magnification side in the rear group is Dfr, and
   Dfr is a value at the wide-angle end in a case where the projection optical system is a variable magnification optical system,
   Conditional Expression (9) is satisfied, which is represented by

$$0.4 < \vert DifP / Dfr \vert < 0. 7 . \qquad ( 9 )$$

### Supplementary Note 18

The projection optical system according to any one of Supplementary Notes 12 to 16, in which the optical path deflection surface is a surface of a prism.

### Supplementary Note 19

The projection optical system according to Supplementary Note 18, in which assuming that
a thickness of the prism along the optical axis is Dpr, and
a refractive index of the prism at the d line is Npr,
Conditional Expression (10) is satisfied, which is represented by

$$0.7 < \vert DifP / ( Dpr / Npr ) \vert < 1.8 . \qquad ( 10 )$$

### Supplementary Note 20

A projection type display device comprising:
the projection optical system according to any one of Supplementary Notes 1 to 19.

What is claimed is:

1. A projection optical system that projects an image on a reduction side to a magnification side,
wherein the projection optical system does not include a reflecting surface having a power,
the projection optical system consists of, in order from the magnification side to the reduction side along an optical path, a first optical system and a second optical system,
an intermediate image is formed between the first optical system and the second optical system,
the first optical system includes an optical path deflection surface which deflects an optical path,
assuming that
a radius of a maximum effective image circle on the reduction side is Imax,
a distance on an optical axis from a lens surface closest to the magnification side in the first optical system to the optical path deflection surface is Ddef, and
Ddef is a value at a wide-angle end in a case where the projection optical system is a variable magnification optical system,
Conditional Expression (1) is satisfied, which is represented by
$$0.2 < Imax / Ddef < 0.7 . \qquad ( 1 )$$

2. The projection optical system according to claim 1,
wherein the first optical system consists of, in order from the magnification side to the reduction side along the optical path, a front group that has a negative power, an optical path deflection member that includes the optical path deflection surface, and a rear group that has a positive power.

3. The projection optical system according to claim 2,
wherein the front group includes one or more positive lenses.

4. The projection optical system according to claim 2,
wherein an outermost periphery of an optical effective surface closest to the magnification side in the first optical system is positioned closer to the reduction side in an optical axis direction than an intersection between the optical effective surface and the optical axis.

5. The projection optical system according to claim 3,
wherein assuming that
an average value of Abbe numbers of all negative lenses included in the front group based on a d line is vnave, and
an average value of Abbe numbers of all positive lenses included in the front group based on the d line is vpave, Conditional Expression (2) is satisfied, which is represented by
$$10 < ν nave - ν pave < 40. \qquad ( 2 )$$

6. The projection optical system according to claim 3,
wherein assuming that
an average value of refractive indexes of all negative lenses included in the front group at a d line is Nnave, and
an average value of refractive indexes of all positive lenses included in the front group at the d line is Npave,
Conditional Expression (3) is satisfied, which is represented by
$$0.15 < Npave - Nnave < 0.45 . \qquad ( 3 )$$

7. The projection optical system according to claim 2,
wherein at least a part of the rear group moves during focusing.

8. The projection optical system according to claim 1,
wherein the second optical system includes two or more movable groups that move along the optical axis during magnification change.

9. The projection optical system according to claim 8,
wherein a movable group closest to the magnification side among the movable groups of the second optical system has a positive power.

10. The projection optical system according to claim 2,
wherein assuming that
an air conversion distance on the optical axis from a surface closest to the reduction side in the front group to a surface closest to the magnification side in the rear group is Dfr, and
Dfr is a value at the wide-angle end in a case where the projection optical system is a variable magnification optical system,
Conditional Expression (4) is satisfied, which is represented by
$$0.5 < Imax / Dfr < 0.9 . \qquad ( 4 )$$

11. The projection optical system according to claim 2,
wherein the optical path deflection surface is a surface of a prism.

12. The projection optical system according to claim 11,
wherein assuming that
a thickness of the prism along the optical axis is Dpr, and
a refractive index of the prism at a d line is Npr,
Conditional Expression (4) is satisfied, which is represented by
$$0.9 < Imax / ( Dpr / Npr ) < 1.3 . \qquad ( 5 )$$

13. The projection optical system according to claim 1,
wherein assuming that
a maximum effective radius of the lens surface closest to the magnification side in the first optical system is ERf, and
a maximum value of maximum effective radii of all lens surfaces of the projection optical system is ERmax,
Conditional Expression (6) is satisfied, which is represented by
$$0 < ERf / ERmax < 0.7 . \qquad ( 6 )$$

14. The projection optical system according to claim 1,
wherein assuming that
a maximum value of a height of an on-axis marginal ray from the optical axis on all lens surfaces of the first optical system is AH1, and
a maximum value of a height of the on-axis marginal ray from the optical axis on all lens surfaces of the second optical system is AH2,
Conditional Expression (7) is satisfied, which is represented by
$$0 < AH 1 / AH 2 < 0.7 . \qquad ( 7 )$$

15. The projection optical system according to claim 1,
wherein the projection optical system includes an aperture stop at a position closer to the reduction side than the intermediate image,
a real image of the aperture stop is present inside the first optical system, and
assuming that
a position of the real image in an optical axis direction is set as a first position, and
a position farthest from the first position is set as a second position, among positions where a ray, which is emitted from an optional point in a maximum effective image circle on the reduction side and passes through a center of the aperture stop toward the magnification side, intersects the optical axis at a position closer to the magnification side than the intermediate image,
an intersection between the optical path deflection surface and the optical axis is positioned within a range from the first position to the second position in the optical axis direction.

16. The projection optical system according to claim 15,
wherein assuming that
a natural number of 1 to 10 is k,
a point, of which a height from the optical axis on the maximum effective image circle on the reduction side is a height of k tenths of a radius of the maximum effective image circle, is a point PHk,
a position, at which a ray that is emitted from the point PHk and that passes through the center of the aperture stop toward the magnification side intersects the optical axis at the position closer to the magnification side than the intermediate image, is a position Pk,
a position, at which an air conversion distance on the optical axis from the first position is longest, among the positions Pk is a third position,
an air conversion distance from the first position to the third position is DifP,
a sign of DifP is positive at a distance on the reduction side and is negative at a distance on the magnification side, in a case where the first position is set as a reference, and
DifP is a value at the wide-angle end in a case where the projection optical system is a variable magnification optical system,
Conditional Expression (8) is satisfied, which is represented by
$$- 3 < DifP / Imax < 0.2 . \qquad ( 8 )$$

17. The projection optical system according to claim 16,
wherein the first optical system consists of, in order from the magnification side to the reduction side along the optical path, a front group, an optical path deflection member that includes the optical path deflection surface, and a rear group, and
assuming that
an air conversion distance on the optical axis from a surface closest to the reduction side in the front group to a surface closest to the magnification side in the rear group is Dfr, and
Dfr is a value at the wide-angle end in a case where the projection optical system is a variable magnification optical system,
Conditional Expression (9) is satisfied, which is represented by
$$0.4 < \vert DifP / Dfr \vert < 0. 7 . \qquad ( 9 )$$

18. The projection optical system according to claim 16,
wherein the optical path deflection surface is a surface of a prism.

19. The projection optical system according to claim 18,
wherein assuming that
a thickness of the prism along the optical axis is Dpr, and
a refractive index of the prism at a d line is Npr,
Conditional Expression (10) is satisfied, which is represented by
$$0.7 < \vert DifP / ( Dpr / Npr ) \vert < 1.8 . \qquad ( 10 )$$

20. A projection type display device comprising:
the projection optical system according to claim 1.
